(19) United States
(12) Patent Application Publication
(10) Pub. No.: US 2001/0052110 A1
(43) Pub. Date: Dec. 13, 2001

(54) System and method for graphically programming operators

(76) Inventors: Julian Orbanes, Cambridge, MA (US); Adriana Guzman, Cambridge, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/784,809

(22) Filed: Feb. 14, 2001

Related U.S. Application Data
(60) Provisional application No. 60/182,326, filed on Feb. 14, 2000.
(60) Provisional application No. 60/182,368, filed on Feb. 14, 2000.
(60) Provisional application No. 60/240,287, filed on Oct. 13, 2000.

(51) Int. Cl. G06F 9/44

(52) U.S. Cl. 717/1

(57) ABSTRACT

A system for graphically connecting operators in a visual programming system. The user is presented with a plurality of graphical representations of operators. The user can invoke a plurality of software articles, such as input and output devices, applications, programs, and the like, and can create a custom application by connecting one or more outputs from one software article to inputs of one or more other software articles. A group of interconnected software articles can be encapsulated, and represented as a user-created software article. In response to a user interconnecting graphical representations of operators, the system automatedly connects the corresponding operators to create a program.

### CROSS-REFERENCE TO RELATED APPLICATIONS

This application claims the benefit of and priority to U.S. provisional patent application Serial No. 60/182,326, filed Feb. 14, 2000, U.S. provisional patent application Serial No. 60/182,368, filed Feb. 14, 2000, U.S. provisional patent application Serial No. 60/240,287, our attorney docket number GPH-003PR2, filed Oct. 13, 2000, U.S. provisional patent application Serial No. not yet assigned, filed Nov. 16, 2000, and U.S. patent application Ser. No.______ , Attorney Docket No. GPH-003, entitled “Method And Apparatus For Viewing Information,” filed on even date herewith, which applications are hereby incorporated in their entirety by reference.

### FIELD OF THE INVENTION

This invention relates generally to visual programming. More particularly, in one embodiment, the invention relates to visual programming in which graphically represented software articles are manipulated to create custom software applications.

### BACKGROUND OF THE INVENTION

Programming environments have come a very long way since the days of punched paper cards. For example, visual programming environments such as Microsoft Visual C++, Basic, and Java provide developers with the ability to quickly develop application prototypes by dragging-and-dropping user interface controls onto WYSIWYG (What you see is what you get) displays. These systems also provide dialogs that enable users to enter values for objects, methods, and data instead of having to code software line-by-line. Some integrated applications allow users to select information from one application, such as a graph created in a spreadsheet, and to use such selected information in a different application, such as imbedding a graph in a word processing document.

However, in general, users cannot interconnect a capability provided by one application sold by a first vendor with a second capability provided by a second application sold by a second, unrelated, vendor without significant expertise, programming skill, and effort. In particular, users cannot interface input devices, such as a mouse or a data source at a remote location, such as a World Wide Web (hereinafter “Web”) site with one or more application programs to create a custom application.

### SUMMARY OF THE INVENTION

In the discussion that follows, the term “software article” will be understood to comprise software ranging from a single line of software code written in any programming language (including machine language, assembly language, and higher level languages), through blocks of software code comprising lines of software code, software objects (as that term is commonly used in the software arts), programs, interpreted, compiled, or assembled code, and including entire software application programs, as well as applets, data files, hardware drivers, web servers, sevlets, and clients. A software article can be abstracted, and represented visually, using a specific visual format that will be explained in detail below. The visual representation of a software article can be referred to as an abstracted software article. The term “browser” will be understood to comprise software and/or hardware for navigating, viewing, and interacting with local and/or remote information. Examples of browsers include, but are not limited to Netscape Navigator™ and Communicator™, Internet Explorer™, and Mosaic™.

The invention, in one embodiment, provides systems and methods for a user, having little or no programming skill or experience, to use visual programming to create custom applications that can employ user input, information obtained from remote devices, such as information obtained on the web, and applications programs. The systems and methods of the invention involve the use of one or more computers. In embodiments that involve a plurality of components, the computers are interconnected in a network. The systems and methods of the invention provide abstractions of software articles which include inputs such as a mouse or a keyboard, and outputs, such as a video display or a printer. An abstraction of a software article is an analog of an electronic circuit which provides functionality such as logic, memory, computational capability, and the like, and which includes inputs and outputs for interconnection to allow construction of a specific application circuit.

The user can select software articles from a repository, such as a software library, and can place an abstracted software article on a computer display. The user can interconnect an output of one abstracted software article to an input of another abstracted software article using “wires.” “Wires” are linear graphical structures that are drawn on the computer display by the user. The user can draw “wires” using a pointing device such as a mouse. The user can construct a software application that performs a customized function by the selection and interconnection of abstracted operator software articles (also referred to as “operators”). The operator software articles represented by the abstractions communicate using a common language, with connections via a central hub software article (also referred to as a “hub” ). A bidirectional software adapter (also referred to as an “adapter”) for each software article provides translation between the “native” communication language of the article and the common language of the system. The bidirectional software adapter is transparent to the user. The systems and methods of the invention provide a readily understood, essentially intuitive, graphical environment for program development. The systems and methods of the invention provide feedback that eases program development and debugging. The systems and methods of the invention reduce the technological expertise needed to develop sophisticated applications.

The systems and methods of the invention employ techniques of viewing material on a display that use panning (e.g. two-dimensional motion parallel to the plane of the display) and zooming (e.g. motion perpendicular of the plane of the display). The zooming and panning features enable the user to easily navigate the programmed design over many orders of magnitude to grasp both micro and macro operation. The zoom and pan is smooth and analogous with nearly infinite degrees of zoom and having a nearly infinitely sized display space.

In one aspect, the invention features a visual programming system. The visual programming system includes a hub and one or more adapters, the hub configured to communicate information with the one or more adapters by way of a common protocol, each of the plurality of adapters being configured to communicate information between the hub and an associated operator, and a user input interface that receives input from a user directing interconnection of at least one operator, wherein the system is further adapted to automatedly combine functional aspects of the at least one operator in response to the input from the user.

In one embodiment, each of the one or more adapters is further configured to translate the common protocol to a protocol of the associated operator. In one embodiment, each of the one or more adapters is further configured to translate the common protocol to a protocol of the associated operator, wherein the associated operator communicates according to a communication protocol different from the common protocol. In one embodiment, the system is further adapted to automatedly combine functional aspects of the a first operator and a second operator in response to the input from the user by communicatively connecting the first operator to the hub via a first one of the one or more adapters, and the second operator to the hub via a second one of the one or more adapters.

In one embodiment, each adapter has a first interface substantially identical to a first interface of another adapter. In one embodiment, at least one of the plurality of adapters has a first interface and a second interface, the first and second interfaces communicating bidirectionally. In one embodiment, a number representing a quantity of the adapters that are unique is less than or equal to a number representing a quantity of the operators. In one embodiment, an operator has an input port and an output port, each port communicating at least unidirectionally.

In one embodiment, at least one of the operators is derived from an external source. In one embodiment, the external source is a Web site. In one embodiment, the external source is substantially real-time information source. In one embodiment, the external source is derived from the user. In one embodiment, the external source is a file system. In one embodiment, the external source is a legacy database.

In one embodiment, the visual programming system is further adapted to enable interoperation of a first functional aspect of one the operator with a second functional aspect of the one operator. In one embodiment, the visual programming system is further adapted to contextually activate the functional aspects of the at least one operator.

In one embodiment, at least one of the operators is an application software program. In one embodiment, the system is further adapted to combine functional aspects of a single the operator in response to the input from the user. In one embodiment, the system is further adapted to generate a graphical representation of operation of a functional aspect of at least one the operator. In one embodiment, the functional aspect is an output from the operator. In one embodiment, the system is further adapted to the graphical representation of the operation of the functional aspect substantially in real-time.

In another aspect, the invention relates to a method of visual programming. The method includes receiving input from a user directing interconnection of at least one operators, and automatedly combining functional aspects of the at least one operator in response to the receipt of the input from the user.

In one embodiment, each operator has an associated protocol, and the method further comprises translating from the associated protocol to a common protocol. In one embodiment, the method further comprises translating from the common protocol to the associated protocol of the associated operator. In one embodiment, an operator has an input port and an output port, each port communicating at least unidirectionally.

In one embodiment, at least one of the operators is derived from an external source. In one embodiment, the external source is a Web site. In one embodiment, the external source is substantially real-time information source. In one embodiment, the external source is derived from the user. In one embodiment, the external source is a file system. In one embodiment, the external source is a legacy database.

In one embodiment, at least one of the operators is an application software program. In one embodiment, the method is further adapted to combine functional aspects of a single the operator in response to the graphical input from the user. In one embodiment, the method is further adapted to generate a graphical representation of operation of a functional aspect of at least one the operator. In one embodiment, the functional aspect is an output from the operator. In one embodiment, the method is further adapted to the graphical representation of the operation of the functional aspect substantially in real-time.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is an image of a screenshot of a graphical user interface for a visual programming system, according to an embodiment of the invention;

FIG. 1B shows an example of a connection of a source software article to a destination software article, according to an embodiment of the invention;

FIG. 1C shows a connector having a repeated indication of a source, according to an embodiment of the invention;

FIG. 2 is an image of a screenshot of a graphical user interface for a visual programming system, according to an embodiment of the invention;

FIG. 3A is an image of a screenshot of a graphical user interface for a visual programming system, according to an embodiment of the invention;

FIG. 3B is an image of a schematic of an unconnected abstracted software article, according to an embodiment of the invention;

FIG. 3C is an image of a screenshot depicting several unconnected abstracted software articles, according to an embodiment of the invention;

FIG. 4A is a diagram illustrating a “virtual” camera that a user can maneuver to zoom-in and out of a graphic representation of an application as the application is being developed, according to an embodiment of the invention;

FIG. 4B is a drawing depicting an embodiment of an encapsulation of a plurality of abstractions of software articles, according to principles of the invention;

FIGS. 5A-5D are embodiments of graphic representations of software articles at varying levels of generality, according to principles of the invention;

FIGS. 6A-6D are images of a hierarchy of radial popup menus, according to an embodiment of the invention;

FIG. 7 is a flow diagram of a menu hierarchy, according to an embodiment of the invention;

FIG. 8 is a diagram of a sample architecture for the visual programming system, according to an embodiment of the invention;

FIG. 9 is a diagram of an embodiment of a computer network upon which the invention can be practiced;

FIG. 10 is a conceptual diagram illustrating generation of a virtual display space in accord with an embodiment of the invention;

FIG. 11 is a schematic view depicting multiple viewing perspectives in accordance with an embodiment of the invention;

FIGS. 12A-12C are schematic views depicting data objects modeled as a node tree;

FIG. 13 is a conceptual diagram illustrating use of using a plurality of templates in accordance with the invention;

FIG. 14 is a flowchart depicting a method of rendering detail in accordance with an embodiment of the invention;

FIG. 15 is an illustrative example of rendering detail in accordance with an embodiment of the invention;

FIG. 16 depicts illustrative embodiments of breadcrumb trails in accordance with the invention;

FIG. 17 illustrates use of search terms in accordance with an embodiment of the invention;

FIG. 18 illustrates operation of a visual wormhole, in accordance with an embodiment of the invention;

FIG. 19 is a schematic view depicting a viewing system architecture in accordance with an embodiment of the invention;

FIG. 20 is a schematic view depicting the conversion of a file system directory tree into a hierarchical structure of data objects in accordance with an embodiment of the invention;

FIG. 21 is a schematic view depicting the conversion of a Web page to a hierarchical structure of data objects in accordance with an embodiment of the invention;

FIG. 22 is a schematic view depicting the conversion of a Web page to a hierarchical structure of data objects in accordance with an embodiment of the invention;

FIG. 23 is a schematic diagram depicting the conversion of an XML™ hierarchical structure of data objects to the ZML™ format in accordance with an embodiment of the invention;

FIG. 24 depicts a method of downloading data from/to a server to/from a PDA client, respectively, in accordance with an embodiment of the invention;

FIG. 25 depicts illustrative display images of user viewing perspectives as rendered by a PDA in accordance with an embodiment of the invention;

FIG. 26 depicts illustrative display images of user viewing perspectives as rendered by a wireless telephone in accordance with an embodiment of the invention; and

FIG. 27 is an embodiment of a handheld wireless navigation device that can be used as a user control in conjunction with the viewing system, according to principles of the invention.

### DETAILED DESCRIPTION

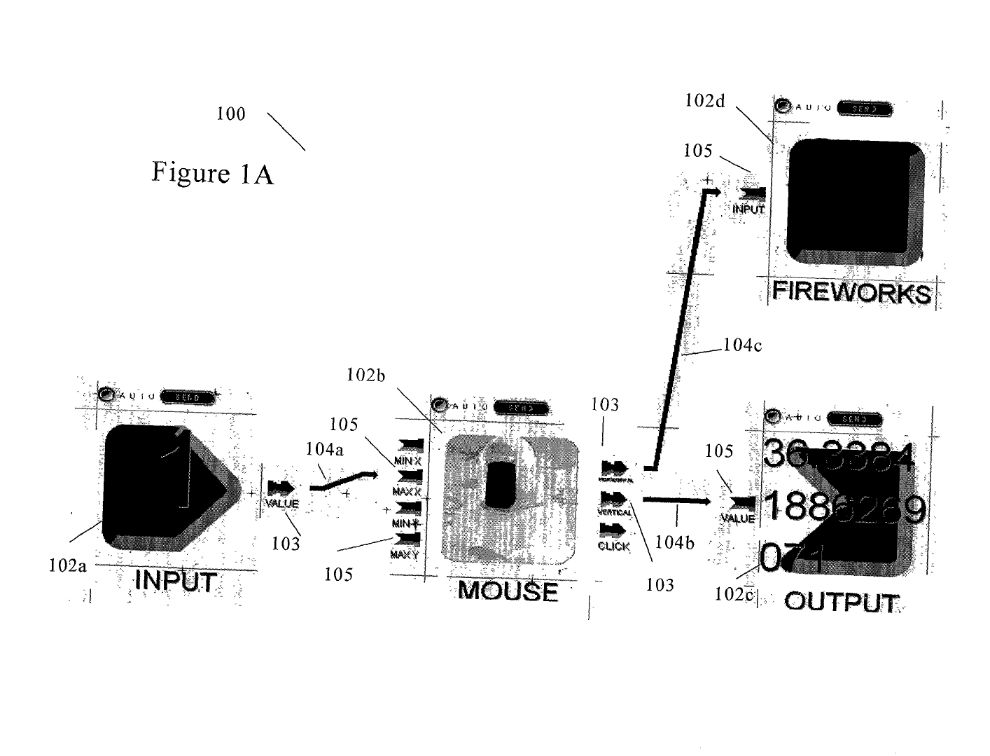

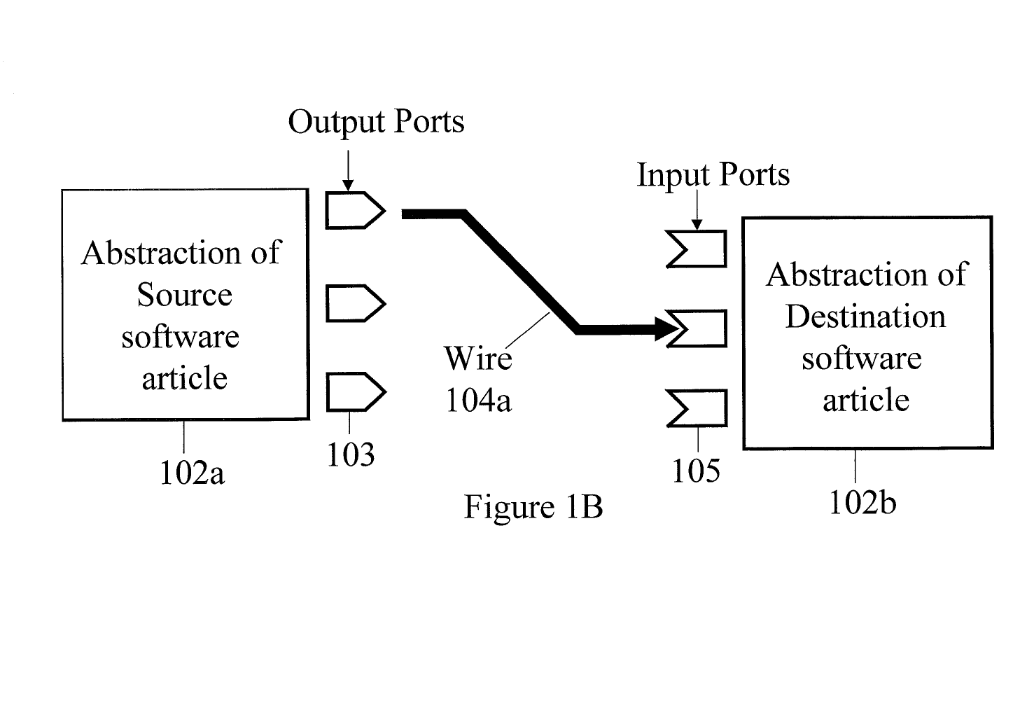

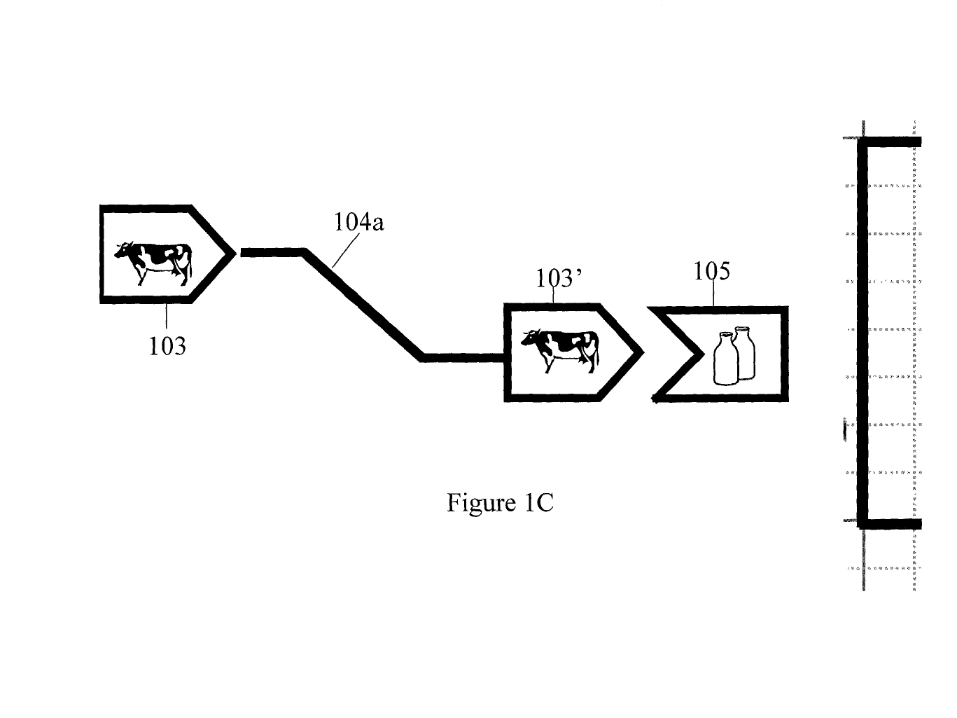

FIG. 1A shows a screenshot of a visual programming system user interface 100. In one embodiment, the interface 100 enables a programmer to quickly assemble an application by assembling and interconnecting different abstractions of software articles 102a-102d. This enables the user to focus on problem-solving using existing abstractions of software articles as the programmer's toolset, instead of spending time writing code to connect the different pieces. The interface 100 provides rich graphic feedback, making application development more intuitive, faster, and enjoyable.

In greater detail, FIG. 1A shows graphic representations of different abstractions of software articles 102a-102d. Each abstraction of a software article 102a-102d provides one or more software services. Examples of software articles include components (e.g., COM/DCOM Objects (Component Object Model/Distributed Component Object Model), ActiveX components, and JavaBeans™), software routines (e.g., C++, Pascal, and Java™ routines), functions provided by commercial products (e.g., Microsoft Excel™ and Word™, MatLab™, and Labview™), and access to a database (e.g., using ODBC (Open Database Connectivity)). A software article may also handle HTTP calls needed to access Internet sites (e.g., retrieving stock prices from a URL (Universal Resource Locator)), e-mail, and FTP (File Transfer Protocol) services. In implementations that support distributive programming, the actual instructions for the software article need not reside on the device displaying the graphical representations.

The user interface presents abstractions of software articles 102a-102d as “black boxes” by representing the software article as having simple input and/or output ports corresponding to software article input and output parameters. In the electronic arts, the term “black box” is used to denote a circuit element having one or more inputs and one or more outputs, but whose detailed internal structure and contents remain hidden from view, or need not be known to the application engineer in detail. In the electronic arts, a “black box” is typically characterized by a transfer function, which relates an output response of the “black box” to an input excitation, thereby providing an engineer with the necessary information to use the “black box” in an application. As shown in FIG. 1, the boxes are not in fact “black,” but can instead present pictures and text that indicate their function and current state. The boxes are “black boxes” to the extent that the programmer does not need to know or understand the precise manner in which the particular box accomplishes the task that it is designed to perform.

To create an application, a user simply connects an output port 103 of an abstraction of a source software article 102a to the input ports 105 of one or more destination abstractions of software articles 102b, as shown in FIG. 1B. The connection is performed by drawing a line or a “wire 104a,” using a pointing device such as a mouse, from an output port 103 on one abstraction of a software article to an input port 105 of an abstraction of a software article. The wire 104a can indicate a direction of information flow. In one embodiment, the drawing is performed by locating a cursor at a desired end of the line, depressing a mouse button, moving the mouse cursor by manipulating the mouse from the beginning of the line to the desired end location of the line, and releasing the mouse button. In alternative embodiments, the user can use a trackball, a keyboard, voice commands or any other convenient suitable input device. In one embodiment, a keyboard can be used by activating particular keys for the functions of moving the cursor (e.g., arrow keys), starting the line (e.g., for example, the combination <Control>-D to denote “pen down”) and ending the line (e.g., for example, the combination <Control>-U to denote “pen up”). Other systems and methods of drawing lines will become apparent to those of ordinary skill in the software arts. In some embodiments, an application can involve connecting a plurality of abstractions of software articles. In some embodiments, an application can involve connecting an output of an abstraction of a software article to an input of the same abstraction of a software article, as when a recursive action is required. According to this embodiment, multiple functional aspects of a single software article can be interconnected to create a program. A more detailed description of the components of abstractions of software articles is given below.

In some embodiments, the system can indicate to the user whether a proposed connection is allowable. In one embodiment, the wire used for a connection is green to indicate an acceptable connection (for example, from an output port to an input port), and the wire turns red to indicate an unacceptable connection (such as from an output port to another output port).

In one embodiment, as the user designates operators, operator functions, and operator function variables, the CommonFace system builds up a connection table which defines the inputs and output of all the wires. The system uses the connection table to determine how data, commands, and the like are translated and transmitted from software article to software article to perform the programmed operations.

Once a connection has been established, the destination abstraction of software article 102b continually receives data or calls from the abstraction of software source article 102a. For example, as shown in FIG. 1A, a user draws a connection 104b from the output port 103 of an abstraction of a “mouse” software article 102b to the input port 105 of an abstraction of an “output” software article 102c. After establishing this connection 104b, the abstraction of the “mouse” software article 102b appears to continually feed the abstraction of the “output” software article 102c with data describing user manipulation of a mouse. The abstraction of the “output” software article 102c appears to display these values in real-time. In fact, the functions described are performed transparently to the user by the associated software articles. Another connection 104c from an output port 103 of the abstraction of the “mouse” software article 102b carries data to an input port 105 of the abstraction of the “fireworks” software article 102d. As depicted in FIG. 1C, in one embodiment, an identifier 103′ of a connection 104a or wire corresponding to an output port 103 can be repeated at either end of the connection 104a, so that the user can see which source is connected to which destination, without having to retrace the entire connection 104a from input port 105 back to output port 103. In one embodiment, the user can select a connection, and the system automatically traverses the connection to display the opposite end of the connection and any associated abstractions.

In some embodiments, selecting a representation of a software article instantiates the underlying software article in response to the system displaying the graphical representation of the software article. For example, selecting an Excel™ spreadsheet causes both the display of an abstraction of the software article, or the display of a graphical representation of the software article, as well as instantiating an Excel™spreadsheet itself. In some embodiments, the graphical representation of the software article serves both to identify the identity of the related software article, and to indicate its state. For example, an Excel™ spreadsheet comprising two columns and two rows can be represented by a graphical representation indicating an Excel™ spreadsheet having two inputs and two outputs, while a spreadsheet with three rows and two columns can be represented by a graphical representation indicating an Excel™ spreadsheet having three inputs and two outputs.

In one embodiment, one graphical representation generates output on its own. In one embodiment, one graphical representation generates output based on input not its own. In one embodiment, one graphical representation performs a function without inputs and without outputs.

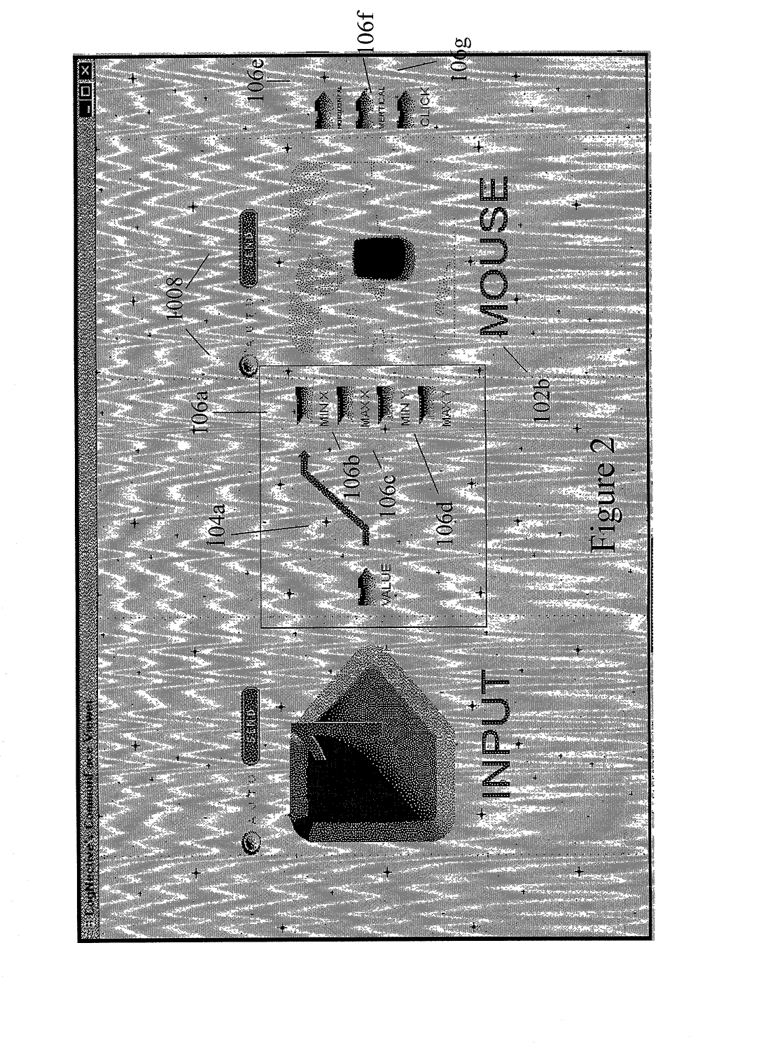

Features referred to as panning and zooming, the operation of which is described in greater detail below with respect to FIGS. 10-25, are shown in FIGS. 1A, 2 and 3A. The user interface 100 provides a “virtual camera” that enables a user to smoothly pan over and zoom in and out of a work space. The “virtual camera” described in more detail below. The detail shown of each abstraction of an article and connection image is a function of the virtual distance between the abstraction and a virtual viewing position of the user, represented by the virtual camera. For example, in FIG. 1 a user has moved the virtual camera far away from the work space. This view displays all abstractions of the application articles 102a-102d and connections 104a-104c. However, in this view, details, such as the names of the software article ports, are difficult to discern. After zooming in (e.g., moving the virtual camera closer to the work space) in FIG. 2, the interface displays greater detail of the portion of the system in view. While zooming in from the virtual camera position of FIG. 1A moves some of the application features out of view, a user can see greater detail such as the ports 106a-106c names, and article configuration information 108, such as a control that determines whether transmission of data between articles is “automatic” or “manual”.

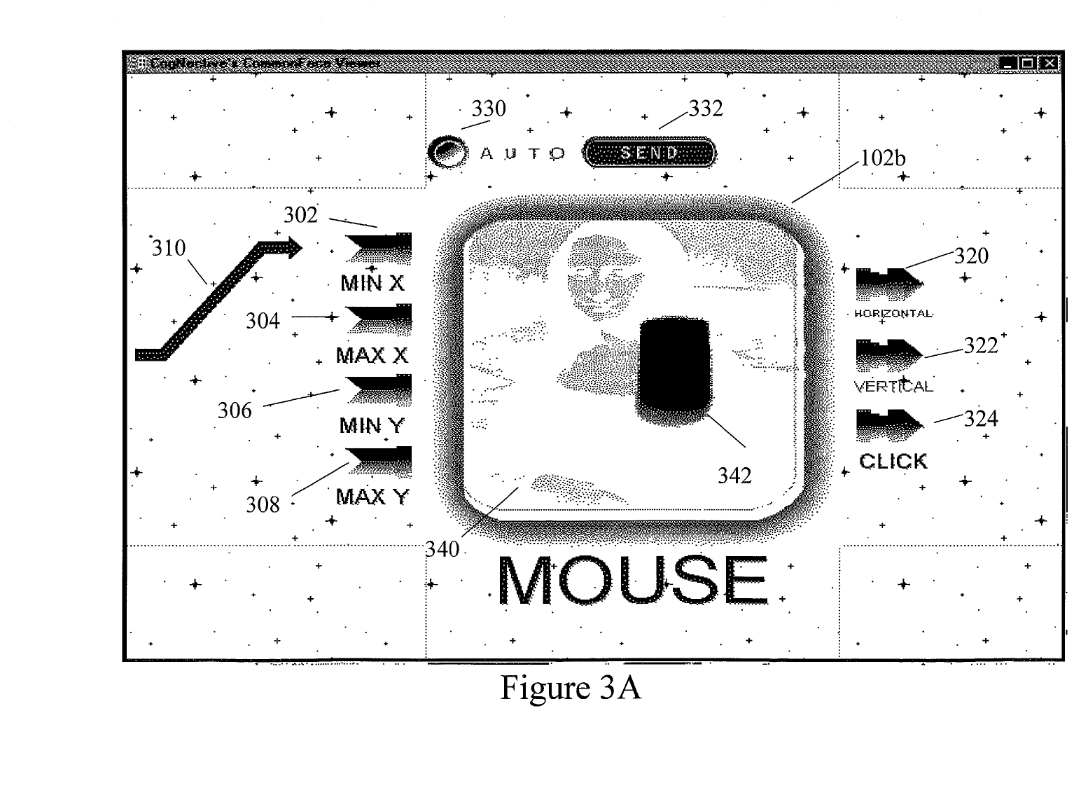

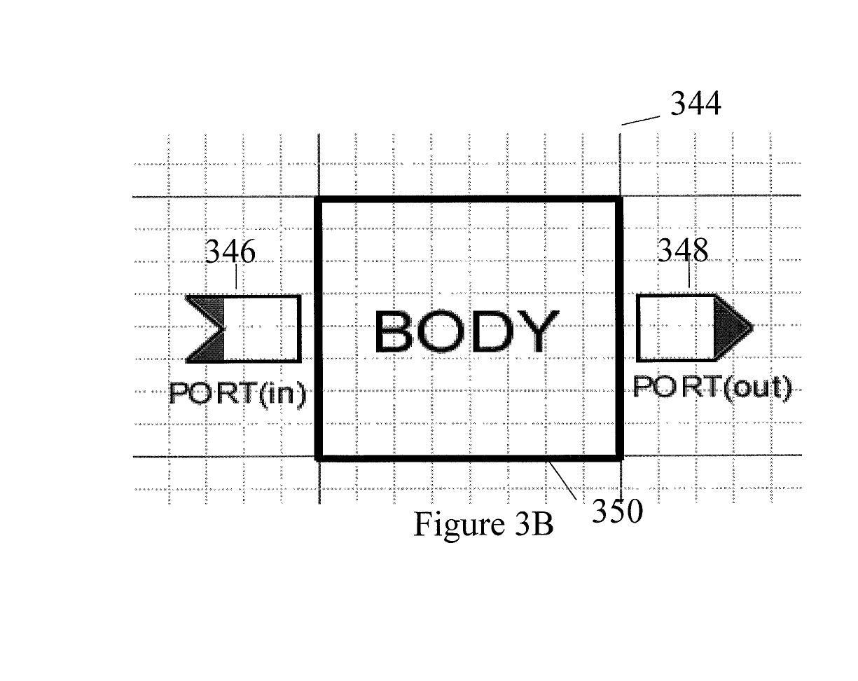

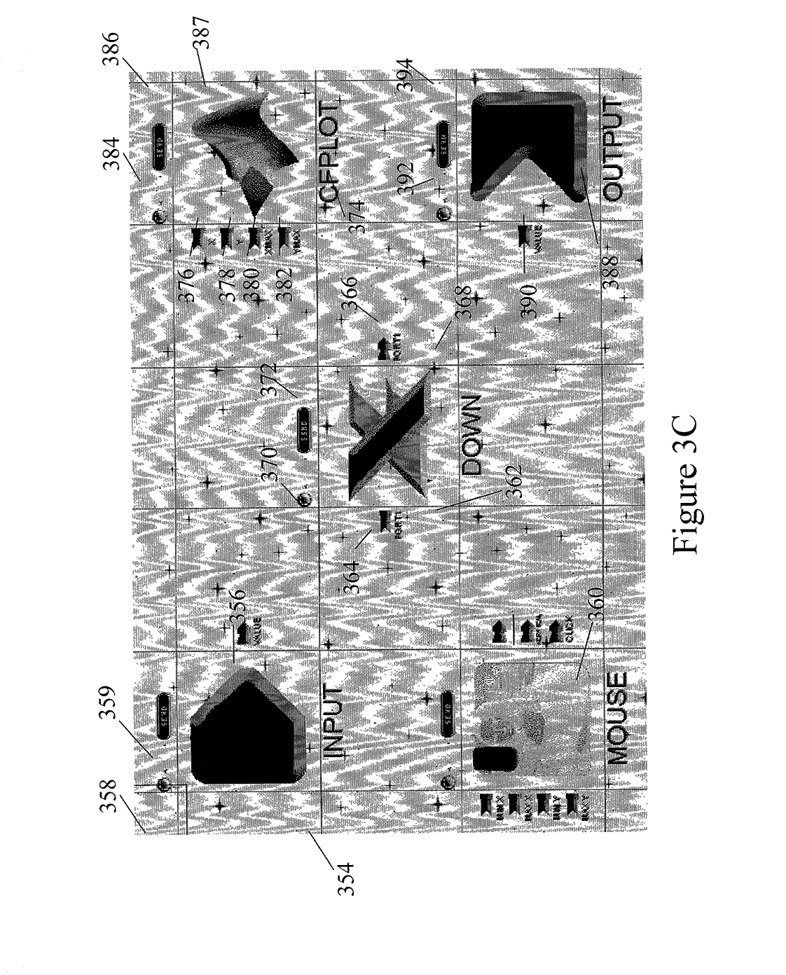

FIG. 3A, which depicts the details of an abstraction of a “mouse” software article 102b, further illustrates the results of zooming in. In this embodiment, the abstraction of the “mouse” software article 102b includes, on the left, input ports, respectively labeled “MIN X” 302, “MAX X” 304, “MINY” 306 and “MAX Y” 308. These inputs define the range of motion of an object, such as a cursor, in Cartesian coordinates, such as columns and rows, respectively, of a display. An input depicted by the line or wire 310 is shown going to port “MIN X” 302 from a source not shown. On the right side of the embodiment are three output ports, respectively labeled “HORIZONTAL” 320, “VERTICAL” 322, and “CLICK” 324. The output ports indicate the horizontal position of a mouse, the vertical position of the mouse, and the state of a mouse button, respectively. In this embodiment, there are two indicators 330, and 332 that indicate whether the software article represented by the abstraction will automatically transmit data (indicator 330 active) or transmit data only upon command of the user who activates indicator 332, for example with a pointing device such as a mouse. Finally, in this embodiment, the abstraction further includes a simulated mouse pad 340 and a simulated mouse 342, which moves about the mouse pad in conformity with the input signals obtained form an associated input device, such as a real mouse pointer operated by the user.

FIG. 3B is an image of a schematic of a generalized unconnected abstracted software article 344. At the left of FIG. 3B is an input port 346, which can accept input information from an abstracted software article. The input port 346 has a concave form indicative of the ability to accept input information. At the right of FIG. 3B is an output port 348, which can transmit information to an abstracted software article. The output port 348 has a convex form indicative of the ability to transmit output information. The center of FIG. 3B is a body 350 which represents the processing and control functions of the abstracted software article 344. The body 350 can also be used to express visually for the benefit of a user information about the capabilities, functions and/or features of the abstracted software article 344, and the software article that it represents. In some embodiments, the body 350 can be augmented with text indicative of some feature or description that informs the user of the purpose and capabilities of the abstracted software article 344, and the software article that it represents.

FIG. 3C is an image of a screenshot 352 depicting several unconnected embodiments of abstracted software articles. In the upper left of FIG. 3C, there is shown an embodiment of a generic abstraction of an “input” software article 354, having a single output port labeled “VALUE” 356 and having two indicators 358 and 359, that correspond, respectively, to the indicators 330 and 332 described above. The abstracted “input” software article 354 is useful for accepting input of a value from, for example, a keyboard, a touchscreen, or a digital input such as an analog-to digital converter. In the lower left is another depiction 360 of an embodiment of the abstraction of the mouse software article 102b of FIGS. 1 and 3A. At the center of FIG. 3C is depicted an embodiment of an abstraction of an Excel™ software article 362, that comprises an input port on the left side having a concave form indicative of an input direction, and labeled “PORT 1” 364, an output port on the right side having a convex form indicative of an output direction, and labeled “PORT 1” 366, an iconic representation 368 that a user can recognize as an Excel™ application, and two indicators 370 and 372, that correspond, respectively, to the indicators 330 and 332, described above.

At the upper right of FIG. 3C is depicted an embodiment of an abstraction of a MatLab™ software article 374, that has four input ports 376, 378, 380 and 382, respectively labeled “X,” “Y,” “XMAX,” and “YMAX.” These ports, respectively, accept input corresponding to values of an x variable, a y variable, the maximum value the x variable can attain, and the maximum value the y variable can attain. At the top of the abstracted MatLab™ software article 374, there are two indicators 384 and 386 that correspond, respectively, to the indicators 330 and 332 described above. The embodiment of the abstraction of the MatLab™ software article 374 further comprises a body that is an iconic representation 387 that a user can recognize as a MatLab™ application. At the lower right of FIG. 3C is depicted an embodiment of an abstraction of an “output” software article 388, having a single input port labeled “VALUE” 390 and having two indicators 392,394, that correspond, respectively, to the indicators 330 and 332 described above. The abstracted “output” software article 388 is useful for displaying a value, for example to a video display, or to a printer, or both.

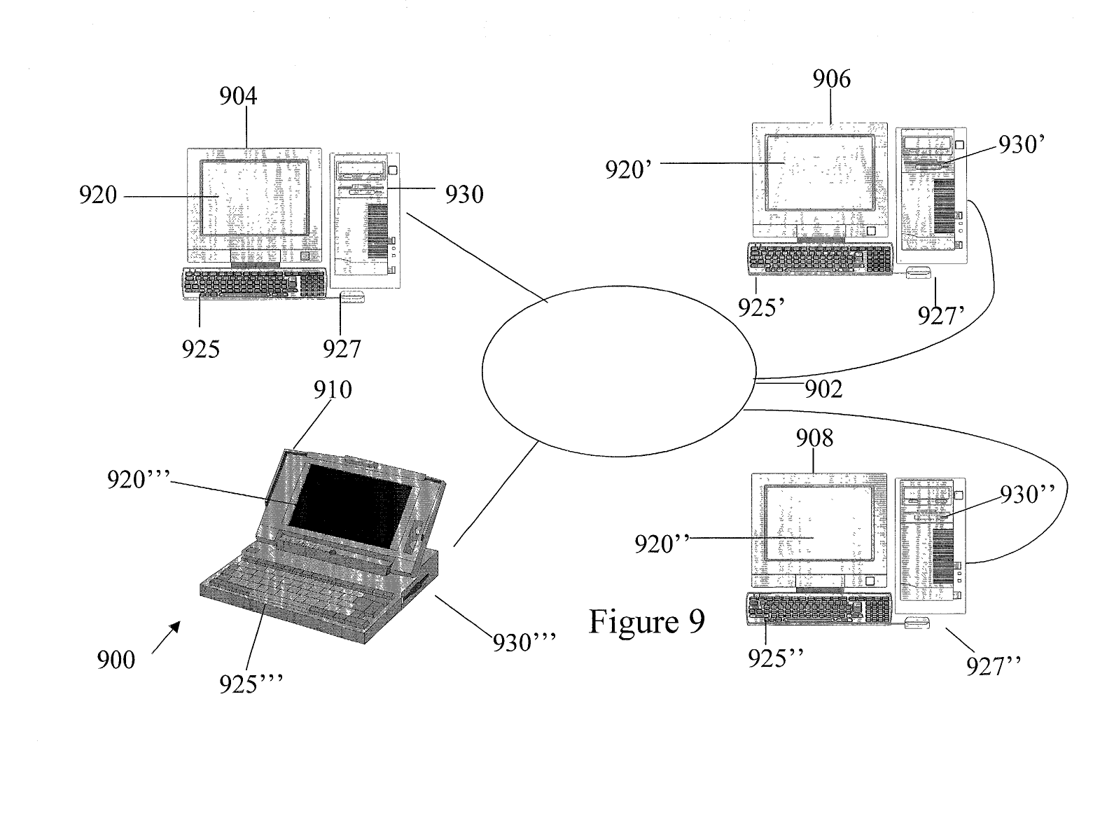

The zooming and panning features enable the user to easily navigate the programmed design over many orders of magnitude to grasp both micro and macro operation. The zoom and pan is smooth and analogous with nearly infinite degrees of zoom and having a nearly infinitely sized display space. A user can, however, “bookmark” different coordinates or use system provided “bookmarks.” A “bookmark” indicates is a virtual display position that has been assumed at some time by the virtual camera, and recorded for future use, so as to return the virtual camera to a specific location. For example, user interface buttons (not shown) enable a programmer to quickly move a camera to preset distances from a plane upon which the abstractions of software articles appear. As discussed in further detail below with respect to FIGS. 9-24, the bookmarked position can be anywhere in a multi-dimensional display space.

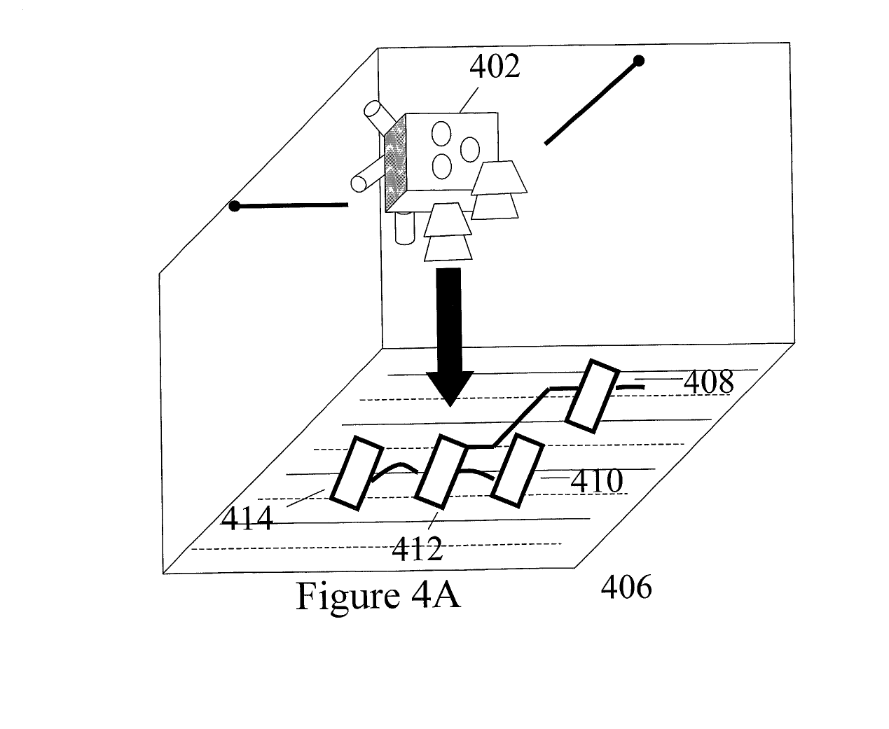

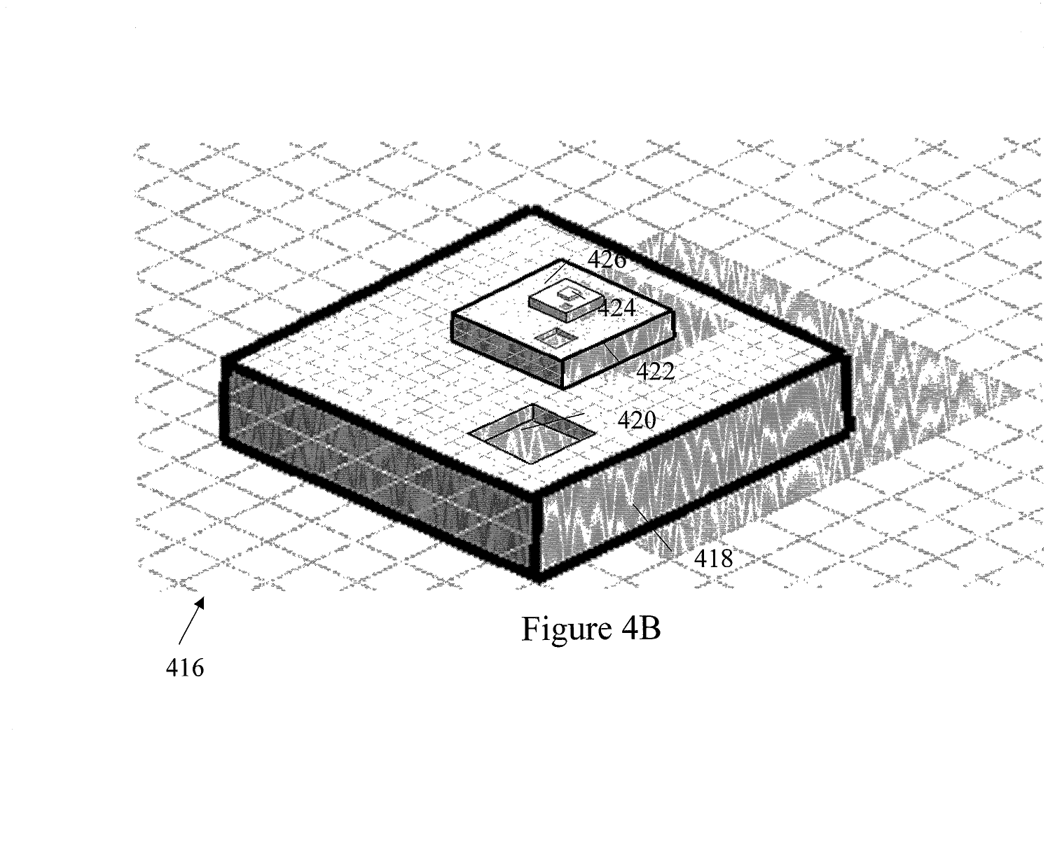

As shown in FIG. 4A, the virtual camera 402 can move in any dimension in the display space 404. Preferably, the camera 402 is axially fixed. That is, while a user can freely move the camera 402 along the z-axis, and translate the camera coordinates along the x-axis and the y-axis, the user may not rotate the camera. This restriction on the number of degrees of freedom of the virtual camera eases camera control. However, in other embodiments the user and thus, the camera 402 can also move rotationally. A variety of three-dimensional graphics engines can be used to provide the virtual camera. In one embodiment, the Java™ JAZZ™ zooming library package is used.

As shown in FIG. 4A, the application under development, represented by the interconnected software articles 408, 410, 412 and 414, may appear on a single flat hierarchical plane 406. However, the system does not impose this constraint. Other implementations may feature software article representations, located on multiple hierarchical planes having differing z-axis coordinates. For example, a user can usually elevate important perhaps (high-level) design features. Additionally, a user can encapsulate collections of software articles into a single larger article. Such important or encapsulated articles may also appear elevated. Although shown in Cartesian space, the articles can also appear in cylindrical, spherical, or other spaces described by different multi-dimensional coordinate systems.

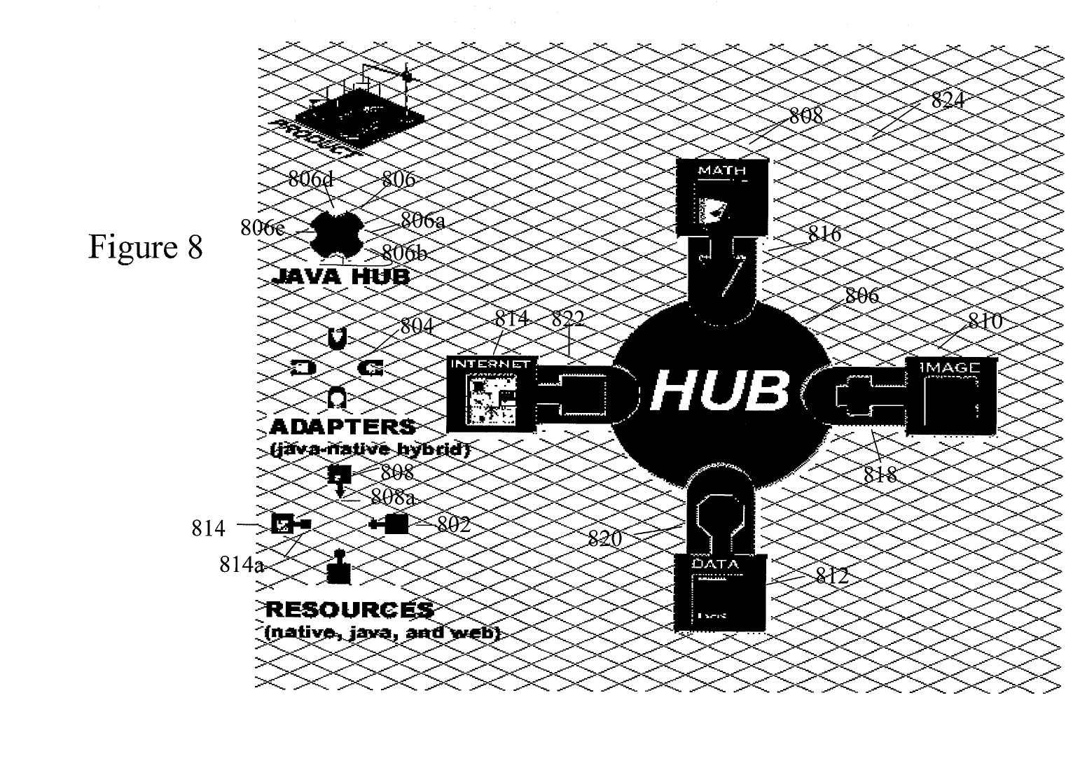

FIG. 4B is a drawing 416 depicting an embodiment of an encapsulation 418 of a plurality of abstractions of software articles. In FIG. 4B, a plurality of software articles have been encapsulated by first connecting the plurality of abstracted software articles as the user desires, leaving at least one port 420 unconnected. FIG. 4B depicts the encapsulated plurality of abstracted software articles 418 to the user as one larger abstracted software article having as input ports those unconnected input ports, if any, of the individual abstracted software articles that are part of the encapsulation, and having as output ports those unconnected output ports, if any, of the individual abstracted software articles that are part of the encapsulation. The system creates a software article that corresponds to the encapsulated abstraction by combining the corresponding software articles in the corresponding manner to that carried out by the user. In a preferred embodiment, the system performs this interconnection using Java™ adapters which involve Active X and JNI components. These adapters are described in greater detail below with regard to FIG. 8. When viewed from a large virtual distance, the encapsulated plurality of abstractions 420 appears to be a single abstraction 418 of a single software article. However, as the view of the encapsulation is increased in size by viewing the encapsulated plurality of abstractions from a virtually close distance, the system displays the internal components of the encapsulation to the user to enable the user to recognize that the encapsulation comprises a plurality of interconnected abstractions of software articles. As depicted in FIG. 4B, an encapsulated software article can be a component of a further encapsulation. In FIG. 4B, three levels of encapsulation are indicated by encapsulated software articles 422, 424 and 426, where 424 contains 426 as a component and 422 contains 424.

The user-interface provides full-color graphics and animation to visually express the function and state of system software articles and connections. Additionally, in some embodiments, a system can be “live” during development. In such cases, the system animates and updates the system display to reflect the current system state. The “wires” 104a-104c or lines used to connect two ports can depict the activity of transmitting information or signals between the two ports. In some embodiments, the “wire” 104a-104c can change appearance to indicate activity in progress. For example, the “wire” 104a-104c can change color during periods of activity. Alternatively, or in addition, the “wire” 104a-104c can change width during periods of activity. In some embodiments, the “wire” 104a-104c can change appearance from one end to the other, such as simulating an activity meter, the extent of the changed portion indicating the progress of the transmission from 0% to 100% as the transmission occurs. In some embodiments, the “wire” 104a-104c can flash or blink to indicate activity. In other embodiments, images of objects such as a person running while carrying an item, a train travelling, a car moving, or the like can “run” along the “wire” 104a-104c to indicate transmission of information.

The visualization system can access a potentially infinitely large workspace, because it can pan in two dimensions along the plane of a workspace, and because it can zoom closer to and further from a plane of the workspace. The system can display an area which represents a portion of the workspace, the area of which depends on the relative virtual distance between the virtual camera and the plane of the workspace, and the location of which depends on the position of the virtual camera with regard to coordinates, such as Cartesian coordinates, defined on the plane of the workspace.

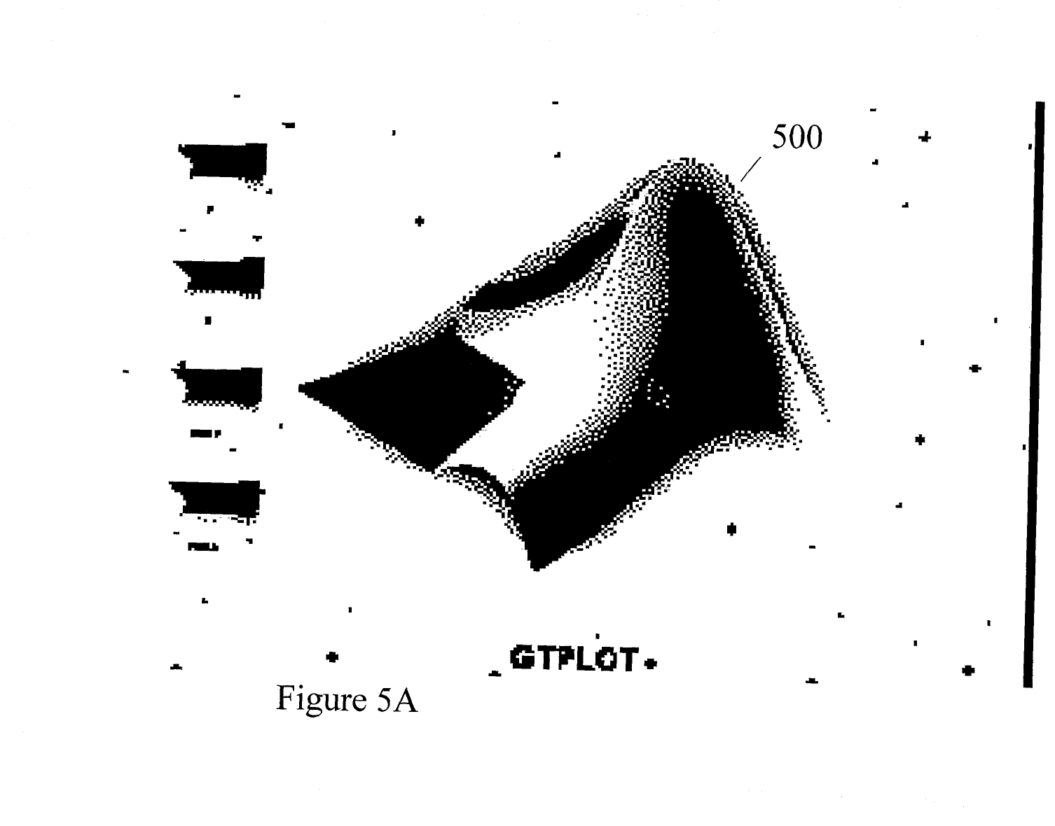

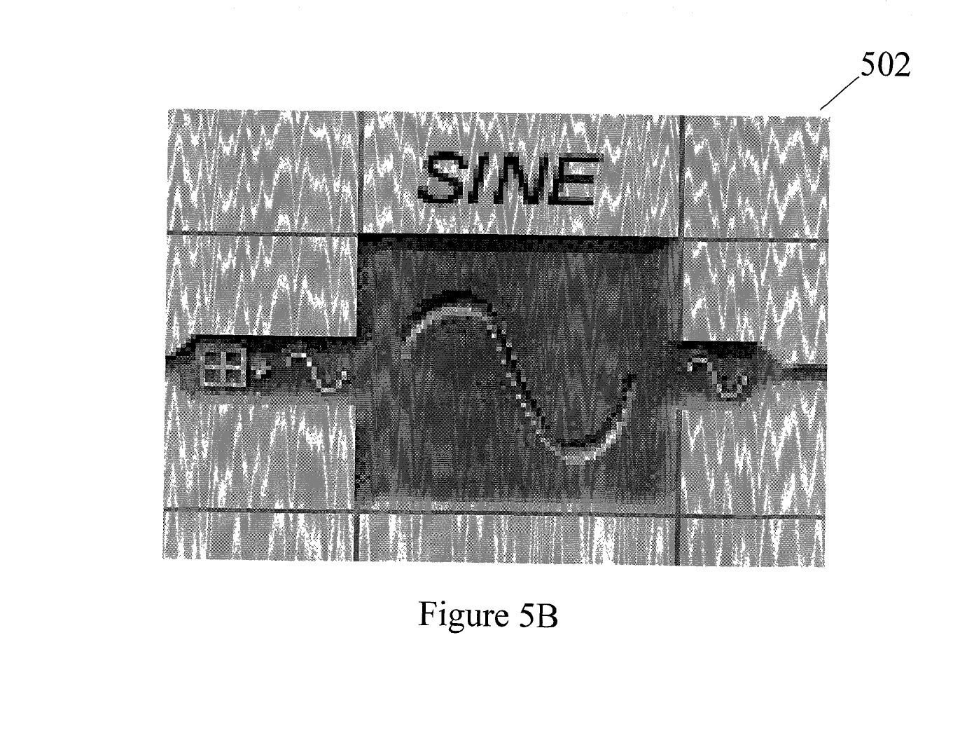

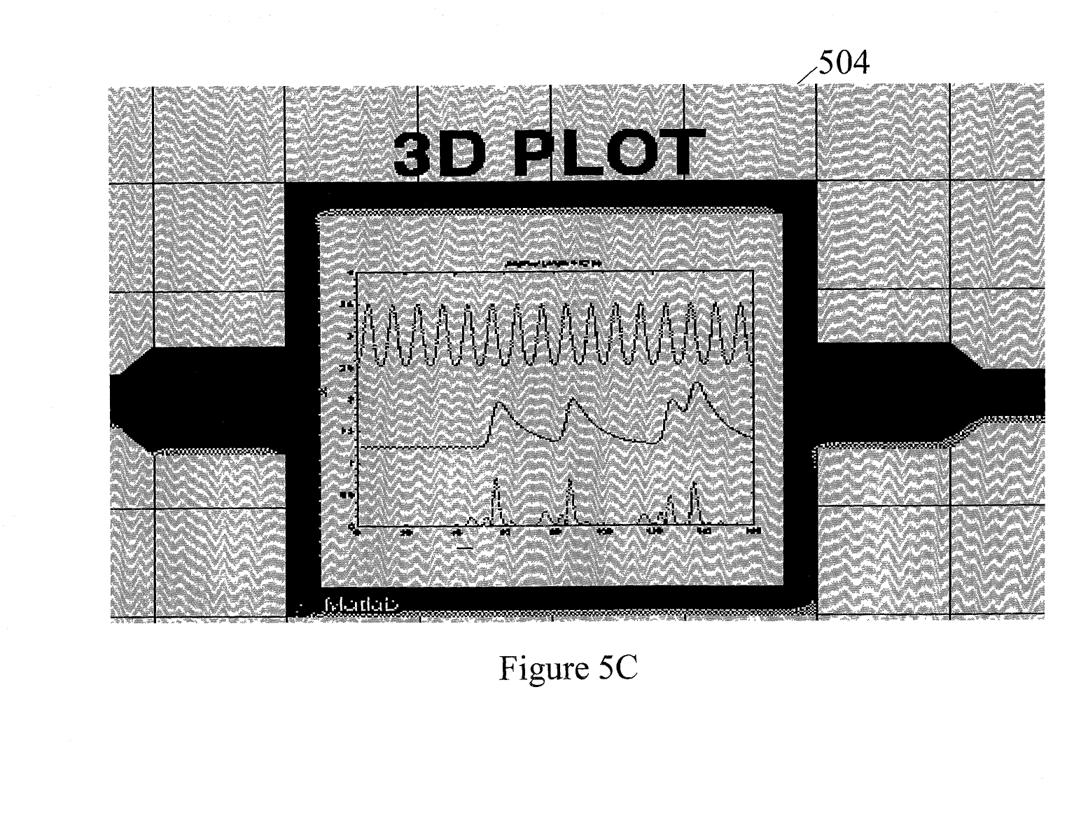

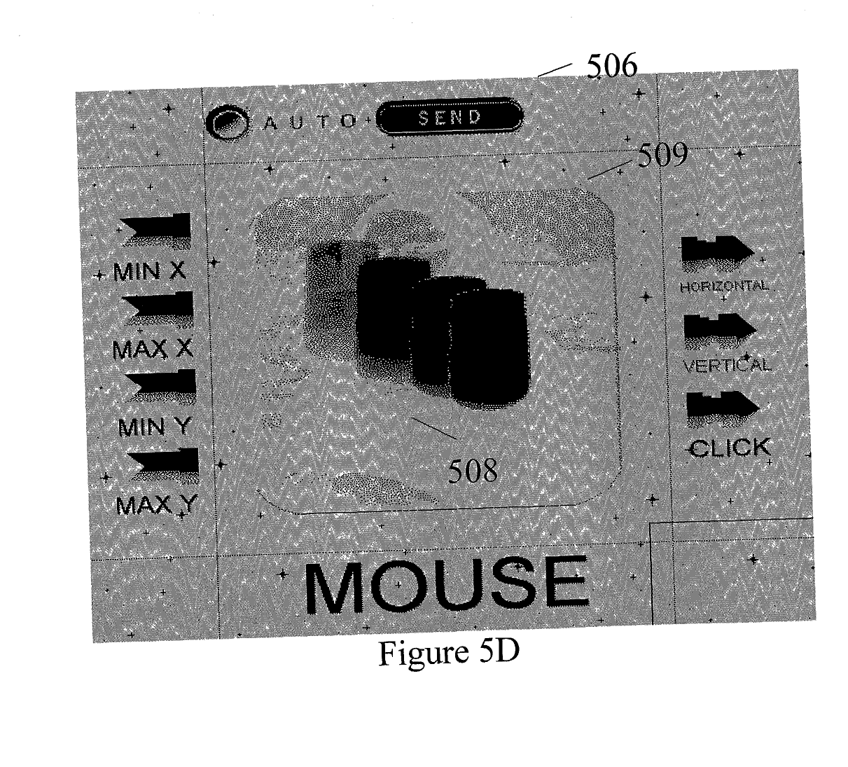

The system can depict abstractions of software articles using a variety of techniques. As shown in FIGS. 5A-5D, abstractions of software articles may be depicted in a variety of ways. In FIG. 5A, an abstraction of a software article is depicted as a product icon 500. The embodiment depicted is that of a graphical display that plots mathematical functions. This provides quick identification of the capabilities a software article underlying a particular abstraction. As shown in FIG. 5B, abstractions of software articles may also be depicted with a more functionally descriptive icon 502 (e.g., a sine wave for a sine wave generator), and may additionally carry an alphanumeric label.

Abstractions of software articles may also include updated graphics 504 and 506 or text reflecting current operation of the software article. For example, in FIG. 5C, the abstraction of software article 504 shows the state of a MatLab™ plotting tool by depicting the graph being plotted. As another example, in FIG. 5D, the abstraction of software article 506 features a real-time visualization of the state (e.g., coordinates and button operation) of an abstraction of a mouse software article. The mouse 508 moves around in real-time on the virtual “mouse-pad” 509 synchronously with the user moving a real physical mouse pointing device. To give the illusion of continuous feedback, the frame-rate is preferably 15 frames/sec or greater. By comparison, to save transmission bandwidth, the mouse can alternatively be represented at a slower frame rate, for example as a display such as that of FIG. 5A, in which motion is not apparent at all, or in which the motion is discontinuous, and the mouse appears to move in a hesitating manner.

The system eases development by providing, at input ports, a graphic indicator that identifies the source port of a software article, along with an indicator at output ports that identifies a destination. For example, an output port of a matrix operation may be a small icon of a grid. Thus, a user can identify the input source without tracing the wire back. The interface can also display the state of the software article ports. For example, ports can provide visualizations of the data that is being imported or exported (e.g., an image received by a software article may be represented with a “thumbnail,” or iconic image of the image transferred).

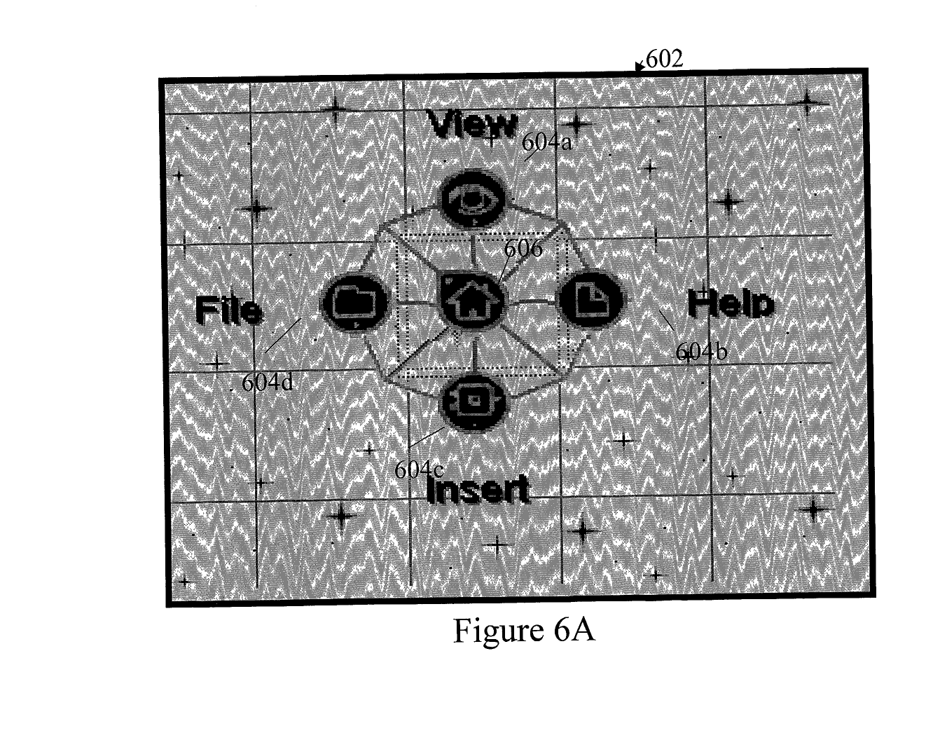

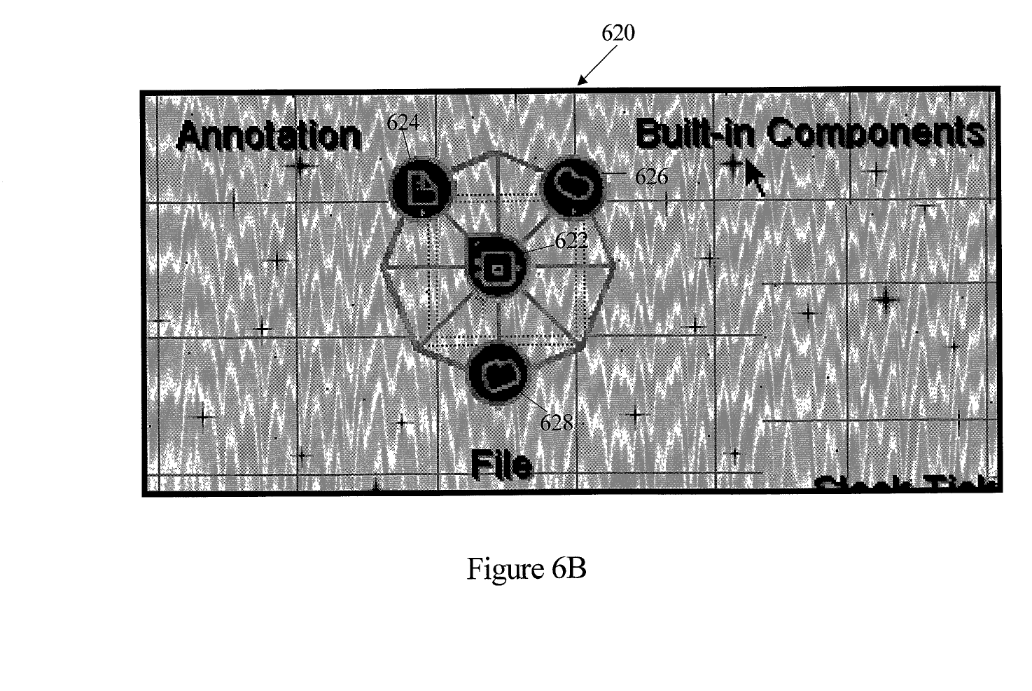

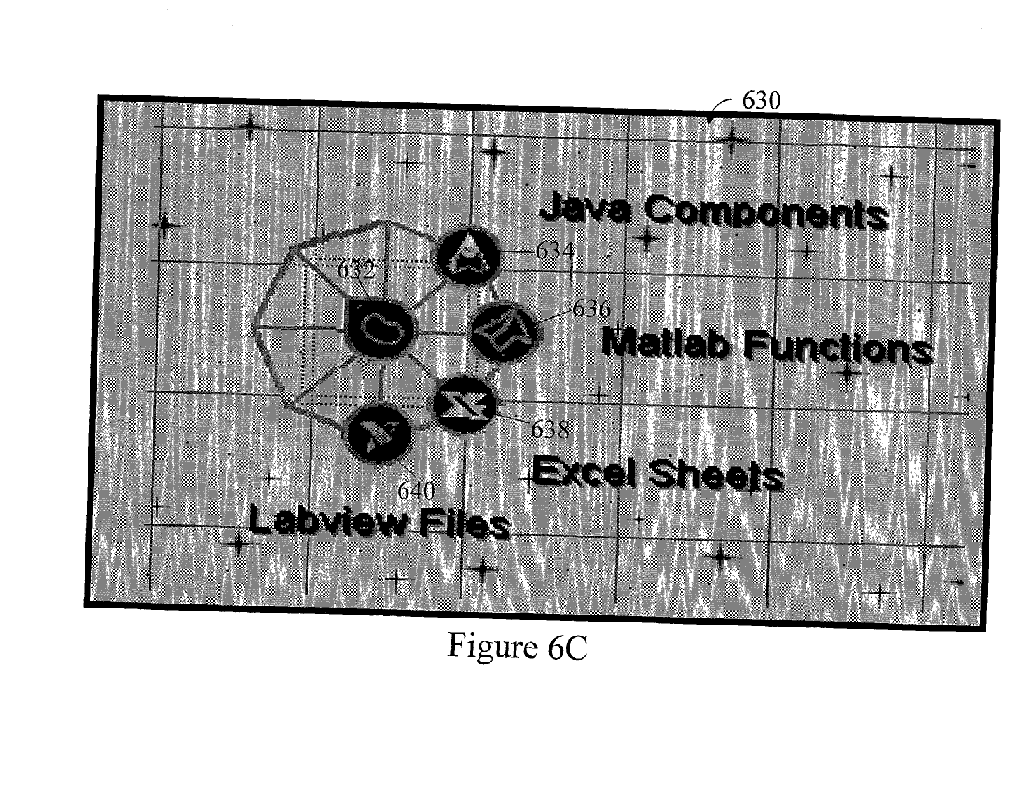

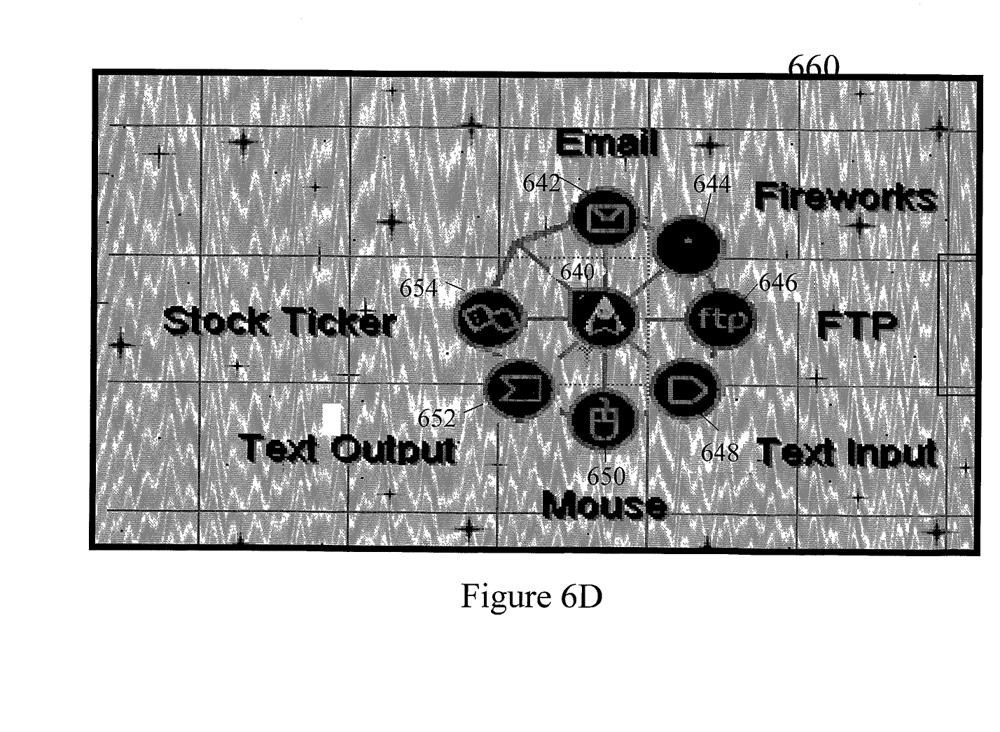

As shown in FIG. 6A, the user interface also features hierarchical radial menus 602. The menu 602 operates like traditional hierarchical menus (e.g., a Windows 98™ menu bar), however, each menu option 604a-604d appears equidistant from a center point 606. The menu 602 allows efficient access to the options 604a-604d by minimizing the amount of mouse movement needed to reach an option.

As shown, the options 604a-604d occur at regular intervals around a circumference about the center point 606. That is, an option appears at an angular position every [(360)/(number of menu options)] degrees. For example, an embodiment of an eight option menu features options located at North-West, North, North-East, East, South-East, South, South-West, and West. Each option 604a-604d can appear as a circular text-labeled icon that highlights upon being co-located with a cursor (e.g., “mouse-over”). A user activating the center option 606 moves the displayed menu up one level of hierarchy. A user activating the outer options 604a-604d either causes the display of another radial menu one level lower in the hierarchy, or causes a command to be executed if there is no lower hierarchy of commands corresponding to the selection activated (e.g., the activated menu option is a leaf of a menu tree, as explained further below).

Preferably, the radial menu 602 is context-sensitive. For example, given a history of user interaction, application state, and user selected items, the system can determine a menu of relevant options. In one embodiment, the radial menu 602 that appears is also dependent on the location of the cursor when the radial menu 602 is activated.

By default, the radial menu is defined not to appear on the user interface to conserve screen real-estate. A user can call up the menu as needed, for example, by clicking a right-most mouse button. An embodiment of a menu system in which the menu is normally hidden from view, and in which the menu appears on command, is called a popup menu system. Preferably, the location of the mouse cursor at the time the mouse button is clicked is used as the center-point 606 of the radial menu 602. The embodiments of the menu system shown in FIGS. 6A-6D are radial popup menus.

FIGS. 6A-6D are images of a hierarchy of radial popup menus (referred to as “RadPop” menus). FIG. 6A shows an embodiment of a uppermost hierarchical level of a RadPop menu 602. In this embodiment, the central menu option, labeled “Home” 606, is located at the position that the cursor occupies when the right mouse button is depressed, activating the RadPop menu system. Activation of the centrally located menu option “Home” 606 causes the RadPop menu 602 to close, or to cease being displayed. The uppermost hierarchical level menu 602 has four options 604a, 604b, 604c and 604d located at angular positions 90 degrees apart. In this embodiment, a first option 604a is the View option, which, if activated, changes a view of the video display. A second option 604b is the Help option, which, if activated, displays a help screen. A third option 604c is the Insert option, which, if activated, opens a lower level menu of insertion action options. A fourth option 604d is the file option, which, if activated, opens a menu of actions that can be performed on a file. In this embodiment, the user selects the insert option, 604c, and the system responds by opening the next lower level of options as another RadPop 620 (see FIG. 3B) whose central menu option overlays the central menu option of the higher hierarchical level RadPop 602.

FIG. 6B shows an image of an embodiment of the RadPop 620. RadPop 620 appears at the same position at which RadPop 602 was displayed. The central menu option is labeled “Insert” 622. Activation of the centrally located menu option “Insert” 622 causes the Insert RadPop menu 620 to close, or to cease being displayed, and to be replaced by the hierarchically next higher Radpop menu, Home 602, of FIG. 6A. The “Insert” 620 RadPop menu has three options, labeled “Annotation” 624, “Built-In Components” 626, and “File” 628, respectively. A user who selects the menu option “Built-In Components” 626 causes the system to move down one additional level in the hierarchy of menus, to FIG. 6C, by closing RadPop 620 and displaying RadPop 630. The menu options “Annotation” 624, and “File” 628, respectively, when activated can cause an action to be performed or can move the user one level down in the hierarchy, depending on how the system is designed.

FIG. 6C shows an image of an embodiment of the RadPop 630. RadPop 630 appears at the same position at which RadPop 620 was displayed. The central menu option is labeled “Built-In Components” 631. Activation of the centrally located menu option “Built-In Components” 631 causes the Insert RadPop menu 630 to close, or to cease being displayed, and to be replaced by the next higher Radpop menu, “Insert” 620, of FIG. 6B, which moves the user up one level in the hierarchy. The “Built-In Components” 632 RadPop menu has four options, labeled “Java™ Components” 634, “MatLab™ Functions” 636, “Excel™ sheets” 638, and “LabView™ Files” 640, respectively. A user who selects the menu option “Java™ Components” 634 causes the system to move down one additional level in the hierarchy of menus, to FIG. 6D.

FIG. 6D shows an image of an embodiment of the RadPop 660. RadPop 660 appears at the same position at which RadPop 630 was displayed. The central menu option is labeled “Java™ Components” 640. Activation of the centrally located menu option “Java™ Components” 640 causes the Java™ Components RadPop menu 660 to close, or to cease being displayed, and to be replaced by the next higher Radpop menu, Built-In Components 630, of FIG. 6D, which moves the user up one level in the hierarchy. The “Java™ Components” RadPop menu 660 has seven radial options, labeled “Email” 642, “Fireworks” 644, “FTP” 646, “Text Input” 648, “Mouse” 650, “Text Cutout” 652, and “Stock Ticker 654, respectively. A user can select any one of the seven radial menu options, each of which opens a respective interaction with the user, in which a component is presented for editing and insertion into a design of an application, as an abstracted software article. For example, in one embodiment, “Stock Ticker” 654 is a component that has the capability to read the statistical information relating to a stock symbol representing a publicly traded stock, mutual fund, bond, government security, option, commodity, or the like, on a regular basis, such as every few seconds. In this embodiment, “Stock Ticker” 654 reads this information via a connection over the Web or the Internet to a site that records such information, such as a brokerage, or a stock exchange. In this embodiment, “Stock Ticker” 654 provides this information as an output stream at an output port of an abstraction of a software article, and the output stream can be connected to other abstractions of software articles, such as an abstraction of a display or output software article for viewing the raw data. In another embodiment, the data stream from the “Stock Ticker” 654 component can be transmitted to one or more software articles, such as an Excel™ spreadsheet software article that can analyze the data according to some analytical function constructed therein, which analyzed data can the n be transmitted to an output software article for display. The application example involving transmitting information obtained by a Stock Ticker to an Excel™ spreadsheet to display is programmed by invoking the Stock Ticker 654 abstraction of a software article, providing a ticker symbol, invoking an Excel™ spreadsheet, entering in the spreadsheet an analytical function (or invoking a spreadsheet that has already been programmed with a suitable analytical function), and invoking an output software article. The software articles appear on the user's computer display as abstractions of software articles previously described. The user wires a connection from an output port of the abstraction of the Stock Ticker software article to an input port of the abstraction of the Excel™ spreadsheet software article, and wires a connection from an output port of the abstraction of the Excel™ spreadsheet software article to an input port of the abstraction of the display software article. The system automatically makes the appropriate connections for data to flow from one software article to the next, as is described in more detail below with regard to FIG. 8. The radial menus of FIGS. 6A-6D enable a user to quickly navigate up and down a hierarchy of levels.

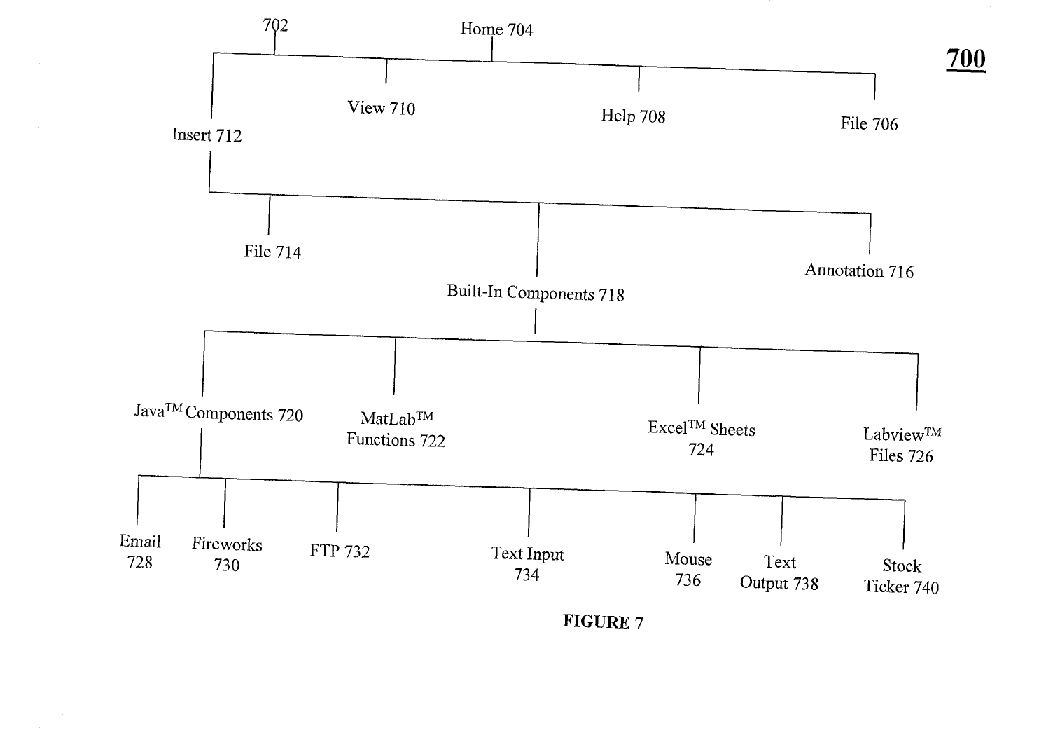

FIG. 7 shows an exemplary hierarchy of menu options 700 in the form of a tree structure 702. As shown, the menu of FIG. 6A is the first hierarchical level. In this embodiment, the tree 702 has as its “root” the node labeled “Home” 704. One level down in the hierarchical tree 702 are four options, “File” 706, “Help” 708, “View” 710, and “Insert” 712. User activation of Insert 712 causes the system to descend an additional level. The next lower level has three menu options, “File” 714, “Annotation” 716, and “Built-In Components” 718. User selection of “Built-In Components” 718 causes the system to descend yet another level. The next level has four menu options, “Java™ Components” 720, “MatLab™” functions 722, “Excel™ Sheets” 724, and “LabView™ Files” 726. When a user triggers the “Java™ Components” 720 menu option, a still lower hierarchical level is reached, which comprises seven components including “Email” 728, “Fireworks” 730, FTP (File Transfer Protocol) 732, “Text Input” 734, “Mouse” 736, “Text Output” 738, and “Stock Ticker”” 740. In this embodiment, use selection of one of the seven menu options last enumerated causes a software article to be activated, and the corresponding abstraction of the software article to be visible on the user's computer display, for customization by the user, for example, indicating what file is desired to be moved using the FTP protocol. 732. As previously indicated with regard to FIGS. 6A-6D, the menu option that connects one hierarchical level with a higher hierarchical level, such as the “Java™ Components” 720 menu option, which connects the two lowest hierarchical levels of the tree 702, also serves as the central menu option for the next lower level, and causes the system to move up a level if activated by the user. Those of ordinary skill in the programming arts will understand that menus having any desired number of menu options, and any number of desired hierarchical levels can be constructed using the systems and methods described herein.

The underlying visual programming system can be implemented using a wide variety of very different architectures. As an example, FIG. 8 shows one embodiment of a visual programming system that uses software article 802 adapter wrappers 804 to make different articles 802 uniformly accessible to a middle-ware hub 806 software article. In one embodiment, the hub software article 806 is depicted as having four docking ports, which are shown as concave semicircular ports 806a-806d. The hub software article 806 can have a plurality of docking ports, limited in number only by the time delays associated with transmitting information between ports. The hub 806 monitors the states of different software articles 802, and initiates and handles communication between the software articles 808.

The software articles 802 and their respective adapters 804 have equal access to system resources. In a preferred embodiment, the software articles 802 are abstracted as Java™ code modules, such as Java™ Serialization or Extensible Mark-up Language (XML™). The system has the property of persistence of state, in which a model can be saved (e.g., appear to be shut down) and restored later, appearing to “remember” where it was when it was last saved.

CommonFace systems may be saved, shared, loaded, and created using a mark-up language similar to HTML, XML and other tag based languages. In one embodiment, tags include: <component>, <wire>, In one embodiment, <component> attributes include: type, id. In one embodiment, <wire> attributes include: source_component, source_port, target_component, target_port.

An example of CFML(CommonFace MarkUp Language) is presented below:

| | |
|---|---|
| <component type=foo | id=1></component> |
| <component type=bar | id=2></component> |

| | |
|---|---|
| <wire | source_component=1 source_port=port_1 |
| | target_component=2 target_port=port_x></wire> |

In greater detail, the hub 806 maintains an object model (e.g., a Java™ data structure) of application software articles 802 and software article connections. When a user adds or deletes operator software articles 802, the system correspondingly updates the object model. Similarly, when a user specifies an operator software article connection, the system represents this in the object model by identifying the desired transfer of data from operator software article A to operator software article B, or the methods or servers to invoke in operator software article B by operator software article A. In one embodiment, communication between operator software articles 802 may be performed using Java™ object passing, a remote procedure call (e.g., RMI (Remote Method Invocation), or a TCP/IP (Transmission Control Protocol/Internet Protocol) based protocol.

FIG. 8 shows four operator software articles, labeled “Math” 808, “Image” 810, “Data” 812, and “Internet” 814, respectively. In some embodiments, each software article accepts input and provides output on a format unique to that software article. For example, in one embodiment, the Math software article 810 uses formats such as integers and floating point values, m×n arrays of data for matrices and vectors (where m and n are positive integers), series of coefficients and powers for polynomials, series of coefficients for Fourier and digital filters, and the like. In one embodiment, the image software article 810 uses one or more of files formatted according to protocols such as the bitmap (.bmp) protocol, the JPEG (.jpg) protocol, or such image file protocols as .tif, gif, .pcx, .cpt, .psd, .pcd, .wmf, .emf, .wpg, .emx, and .fpx. In one embodiment, the Data software article 812 uses formats including, but not limited to, a single bit, a byte, an integer, a long integer, a floating point, a double floating point, a character, and the like. In one embodiment, the Internet software article 814 can use protocols such as TCP/IP, DSL, Component Object Model (COM), and the like. None of the four types of software articles in these exemplary embodiments are capable of communicating directly with any other software article. This incompatibility is denoted graphically by depicting each distinct software article with a terminal that is unique in shape and size, for example, the math software article 808 having an arrow-shaped terminal 808a, and the Internet software article 814 having a square-shaped terminal 814a.

There are also depicted in FIG. 8 four adapter articles 816, 818, 820, and 822. The adapter article 816 has a triangular terminal at one end, which is the mating triangular shape to that of the triangular terminal of the math software article 808. The opposite end of adapter 816 is a convex semicircular shape, which is designed to mate with any of the plurality of terminals of the hub software article 806 having concave semicircular shape. A user can recognize that the adapter article 816 is adapted to communicate bidirectionally with the hub software article 806 on one end and a software article such as the math software article 808 having the appropriate arrow-shaped terminal on the other. In terms of connections which take place in the system, and which are transparent to the user, the adapter 816 is designed to translate between the information flow to and from the hub software article 806 in the native language of the hub software article 806, and the information flow to and from any software article using the protocols that the Math software article 808 uses in the format or formats that such protocol requires. In similar fashion, the adapters 810, 812 and 814 perform similar bidirectional translations between the native language of the hub software article 806 on one end, and the protocols used by a particular kind of software article, such as the Image 810, Data 812 and Internet 814 software articles, respectively. The mating shapes are visual indications to the user as to which adapter functions with which software article. The user need not be aware of, or be troubled by programming the details of the translations that are required. These details are preprogrammed and encompassed in the adapters 816, 818, 820, and 822.

In an exemplary embodiment 824, the hub software article 806 is assembled with the math software article 816, the Image software article 810, the Data software article 812, and the Internet software article 814, using the adapters 816, 818, 820, and 822, respectively. In this embodiment, any software article can communicate with any other software article via the common language of the hub software article, the necessary translations being performed by the adapters 816, 818, 820, and 822.

The utility of the illustrative system is clear upon considering the following mathematical analysis. The system requires at most N adapters such as 816, 818, 820 and 822 for N software articles 808, 810, 812, and 814 to communicate, where N is an integer greater than or equal to 2. By comparison, a system that attempted to connect different software articles using adapters that had dissimilar ends to connect two specific types of software articles would require N*(N−1)/2 different types of adapters (e.g., the number of adapters required to connect two things selected from a set of N things, or equivalently, the number of combinations of N things taken two at a time). However, since hub software article 806 can interconnect many software articles simultaneously, the advantage is in fact even greater, because the number of connectors necessary to interconnect three software articles simultaneously (e.g., allowing software articles A, B, and C to communicate pairwise) is given by the number N*(N−1)*(N−2)/6. The illustrative system of the invention requires only N adapters to connect N software articles in a manner in which any software article can communicate with any other software article where such communication is required. By comparison, a method in which a hub is not employed requires of the order of N² adapters for communication between two software articles, and of the order of N³ adapters for communication between three software articles. The amount of additional programming that would be required for N² or N³ adapters, as compared to N adapters, when N is even moderately large (N>5) is daunting. Furthermore, the additional number of unique adapters required for accommodating a new software article incompatible with any existing adapter in the system of the invention is only one, independent of how many adapters already are in use in the system (e.g., N−(N−1)=1 for any N). While in a system of direct two-way or three-way communication, going from 5 accommodated software articles to 6 accommodated software articles requires 6*5/2−5*4/2=15−10=5 new adapters and 6*5*4/6−5*4*3/6=10=10 new adapters, respectively. When N is larger, the situation favors the system of the invention even more strongly as to accommodating new formats of software articles. A connection may specify process flow or timing relative to the activities of software article A to software article B. For example, communication between software articles may occur manually when a user wants to control data transmission, (e.g., when debugging an application). Communication may also occur automatically. For example, the system may initiate communication when the state of an output port changes.

Software article wrappers such as 816, 818, 820, and 822 may be manually programmed or automatically generated. For example, many commercial programs, such as MatLab™, provide “header” files describing input and output parameters for different procedures. These header files can be parsed to identify the different input and output ports to use and the type of data that is to be transmitted or received (e.g., bit, byte, integer, long integer, floating point, double floating point, character, and the like). Additionally, an entity creating the wrapper can elect to “hide” different parameters or functions from view. Though this may provide visual programmers with a subset of possible functions, this can also eliminate seldom used features from graphical representation, thereby, “uncluttering” the visual programming environment.

A variety of different platforms can provide the visual programming system features described above. These platforms include televisions; personal computers; laptop computers; wearable computers; personal digital assistants; wireless telephones; kiosks; key chain displays; watch displays; touch screens; aircraft, watercraft, and/or automotive displays; video game displays; and the like.

FIG. 9 is a diagram 900 of an embodiment of a computer network upon which the invention can be practiced. In FIG. 9, there a plurality of computers 904, 906, 908, 910, which are depicted as personal computers and a laptop computer. Other kinds of computers, such as workstations, servers, minicomputers, and the like can also be used as part of the network. In the embodiment depicted in FIG. 9, the computers 904, 906, 908, 910 are interconnected by a network 902, which can be a local network, a wide area network, or a world-wide network, such as the Web. Each computer preferably has a display 920, 920′, 920″, 920′″ and/or other output devices to display information to a user. Each computer preferably has one or more input devices, such as a keyboard 925, 925′, 925″, 925′″ or a mouse 927, 927′, 927″, a trackball, or the like. Preferably, each computer has a recording device, such as a floppy disk drive 930, 930′, 930″, 930′″, a hard disk drive, memory, and/or a CD-ROM, for recording information, instructions and the like as necessary. Preferably, each computer has a communication device, such as a modem, a serial port, a parallel ort and/or other communication devices for communicating with other computers on the network.

The techniques described here are not limited to any particular hardware or software configuration. The techniques are applicable in any computing or processing environment. In different embodiments, the techniques can be implemented in hardware, software, or firmware or a combination of the three. Preferably, the techniques are implemented in computer programs executing on one or more programmable computers that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program is preferably implemented in a high level procedural or object oriented programming language to communicate with a computer system. However, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described in this document. The system can be implemented as a computer-readable storage medium, configured with a computer program, where the storage medium so configured causes a computer to operate in a specific and predefined manner.

We now describe the technology of a system for implementing the zooming and panning, and the various hierarchical features relating to both the visualization systems and methods, and the hierarchical nature of the RadPop menus, data, and the like. Although described below in terms of various products and/or services, skilled artisans will appreciate that the operations described below are equally applicable to radpops, software abstractions, and the user's viewing and interacting therewith.

FIG. 10 is a schematic diagram depicting an exemplary viewing system. The viewing system 1000 includes an extractor module 1002, a stylizer module 1004, a protocalizer 1006, user controls 1007, and a display 1008, which presents data objects to the user in a virtual three dimensional space 1010. The data source or sources 1012 may be external to the viewing system 1000, or in some embodiments may be internal to the viewing system 1000. The extractor 1002, stylizer 1004 and protocolizer 1006 operate in conjunction to organize data objects from the data source 1012 and to locate for display those data objects in the virtual three-dimensional space 1010. The virtual three-dimensional space 1010 is depicted to the user as the display space 103 of FIG. 1. Exemplary displayed data objects are shown at 1014a-1014h. The data objects 1014a-1014h can be. For example, the software articles displayed in FIG. 1. Described first below is an illustrative embodiment of the invention from the point of view of the user viewing the data objects 1014a-1014h from an adjustable viewing perspective. Following that description, and beginning with FIG. 19, is an illustrative description of the operation of the extractor module 1002, the stylizer module 1004, the protocolizer 1006, the user controls 1007, and the display 1008.

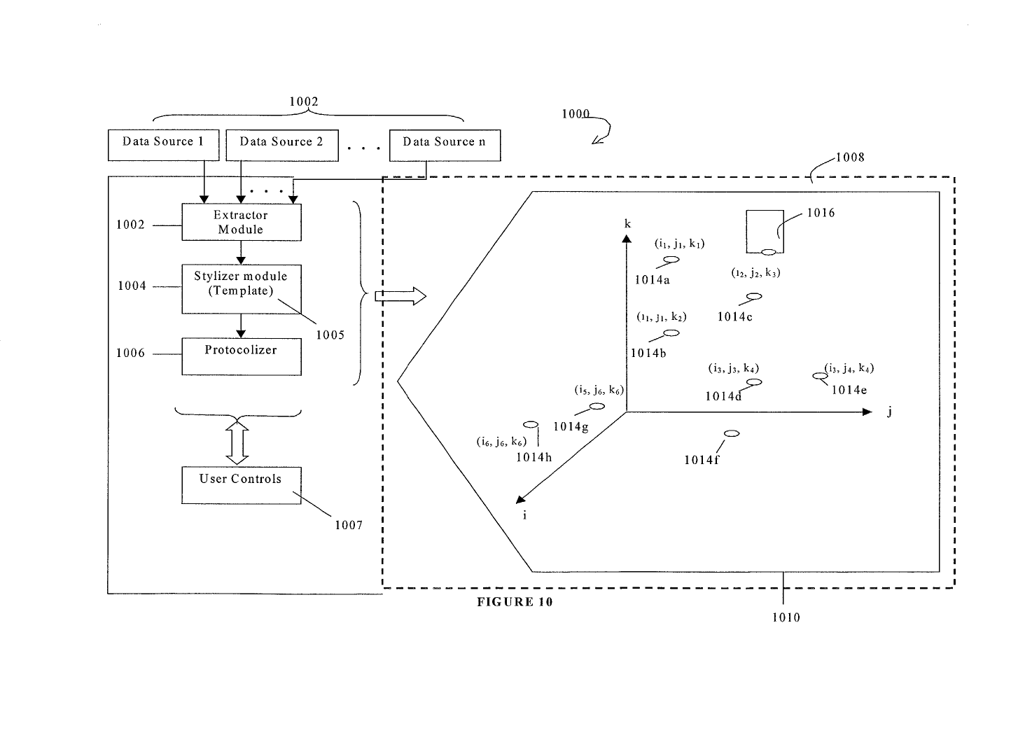

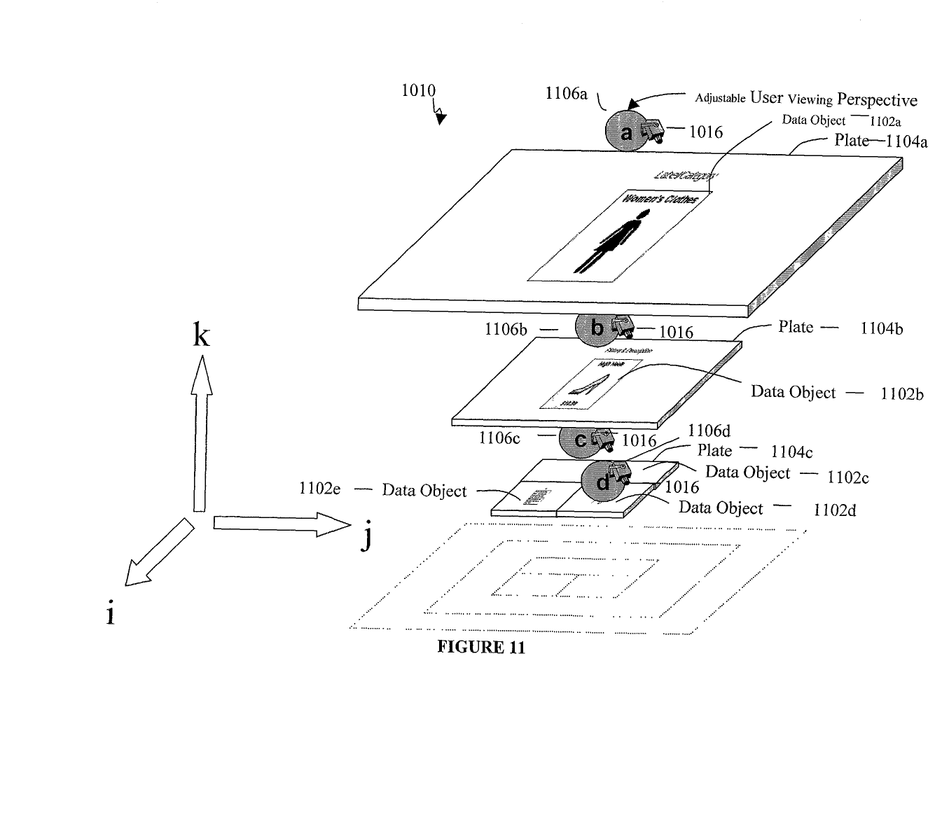

In the virtual space 1010, the adjustable user viewing perspective is represented by the position of a camera 1016. The user manipulates the controls 1007 to change the viewing perspective, and thus the position of the camera 1016. Through such manipulations, the user can travel throughout the virtual space 1010, and view, search through, and interact with, the data objects 1014a-1014g. The illustrative viewing system 1000 enables the user to change the viewing perspective of the camera 1016 in an unrestricted fashion to provide the user with the feeling of traveling anywhere within the virtual space 1010. In the embodiment of FIG. 10, the virtual space 1010 is modeled as a Cartesian, three-dimensional coordinate system. However, other embodiments may include more dimensions. Additionally, the viewing system 1000 may employ other three dimensional coordinate systems, such as cylindrical and spherical coordinate systems may be employed. Further, as discussed below, such as with respect to FIG. 11, the data objects 1014a-1014h may be organized in the virtual space 1010 in a variety of manners.

In one embodiment, the camera 1016 does not rotate, but moves freely along any of the three axes (i.e., i, j, k). By disabling rotation, it becomes easier for the user to remain oriented, and simpler to display the data objects 1014a -1014g. Disabling rotation also reduces the necessary computations and required display information details, which reduces data transfer bandwidths, processor and/or memory performance requirements. In other embodiments the camera 1016 can move rotationally.

As the user adjusts the viewing perspective of the camera 1016, the viewing system 1000 changes the appearance of the data objects 1014a-1014g accordingly. For example, as the user moves the camera 1016 closer to a data object (e.g., 1014a), the viewing system 1000 expands the appearance of the displayed image of the data object (e.g., 1014a). Similarly, as the user moves the camera 1016 farther away from a data object (e.g., 1014a), the viewing system 1000 contracts the image of the data object 1014a. Also, the viewing system 1000 displays the data object closest to the camera 1016 as the largest data object and with the most detail. Alternatively, the viewing system 1000 displays data objects that are relatively farther away from the camera 1016 as smaller and with less detail, with size and detail being a function of the virtual distance from the camera 1016. In this way, the viewing system 1000 provides the user with an impression of depth of the fields. In the Cartesian, three-dimensional coordinate system model of the virtual space 1010, the viewing system 1000 calculates the virtual distance from the camera to each data object using conventional mathematical approaches. In a further embodiment discussed in more detail below, the viewing system 1000 defines the smallest threshold virtual distance, less than which the viewing system 1000 defines as being behind the position of the camera 1016. The viewing system 1000 removes from view those data objects determined to be virtually behind the camera 1016. According to another feature, data objects can be hidden from view by other data objects determined to be virtually closer to the camera 1016.

FIG. 11 provides a diagram that illustrates one way the viewing system 1000 can conceptually organize data objects, such as the data objects 1014a -1014h, depicted in FIG. 10. As depicted in FIG. 11, the viewing system 1000 conceptually organizes the data objects 1102a-1102e on virtual plates 1104a-1104c in the virtual space 1010. As in FIG. 10, the virtual space 1010 is modeled as a three axis (i.e., i, j, k) coordinate system. Again, the position 1106 of a virtual camera 1016 represents the user's viewing perspective. Although not required, to simplify the example, the camera 1016 is fixed rotationally and free to move translationally. The data objects 1102a-1102e are organized on the virtual plates 1104a-1104c in a hierarchical fashion. In the example of FIG. 11, the data objects represent items of clothing and the template employed relates to a clothing store. However, data objects can also represent, for example, various software abstractions, and templates relating to the display of those software abstractions can also be employed as the user views information in the virtual space, as indicated by position “a” 1106a of the camera 1016, the viewing system 1000 illustratively presents an icon or graphical representation for “women's clothes” (data object 1102a). However, as the user visually zooms into the displayed clothing store, as represented by position “b-d” 1106b-1106d of the camera 1016, the viewing system 1000 presents the user increasing detail with regard to specific items sold at the store. As the user virtually navigates closer to a particular plate, the system 100 displays less of the information contained on the particular plate to the user, but displays that portion within view of the user in greater detail. As the user virtually navigates farther away, the system 100 displays more of the information contained on the plate, but with less detail.

As described below, and as shown on the plate 1104c, the same plates may contain multiple data objects, thus enabling the user to pan across data objects on the same plate and zoom in and out to view data objects on other plates. In other embodiments, plates can be various sizes and shapes. Conceptually, each plate 1104a-1104c has a coordinate along the k-axis, and as the user's virtual position, represented by the position 1106 of the camera 1016, moves past the k-axis coordinate for a particular plate, the viewing system 1000 determines that the particular plate is located virtually behind the user, and removes the data objects on that plate from the user's view. Another way to model this is to represent the closest plate, for example the plate 1104a, as a lid and as the user's viewing position 1106 moves past the plate 1104a the viewing system 1000 “removes the lid” (i.e. plate 1104a) to reveal the underlying plates 1104b and 1104c. For example, the closest plate may contain the continent of Europe. At first, when the user's viewing perspective is high along the k-axis, the user may view a map showing Europe displayed as a single entity. Then, as the user visually zooms through that plate and that plate is no longer in view, the viewing system 1000 may display to the user a plurality of European countries organized on a plurality of smaller plates. Alternatively, the viewing system 1000 may display a plurality of European countries organized on a single plate.

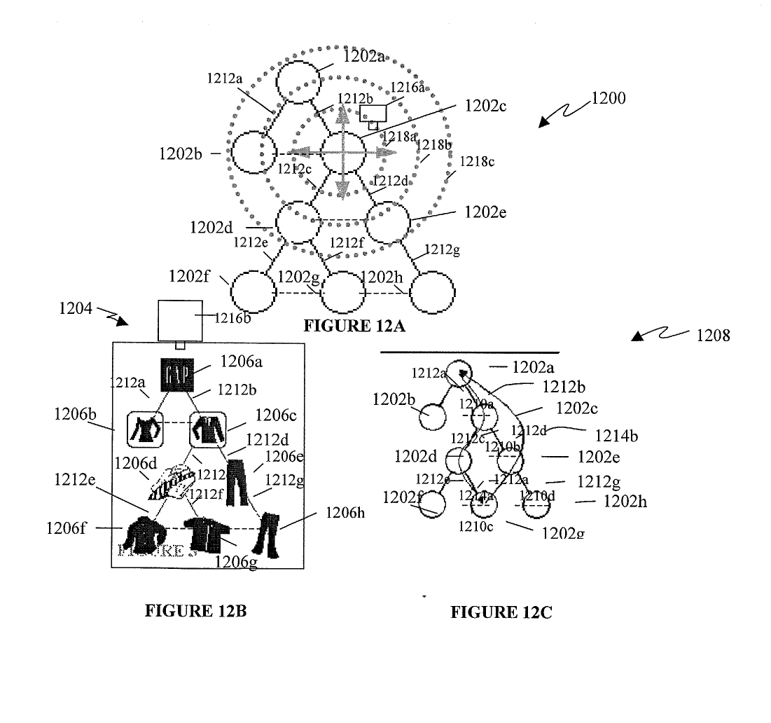

As an alternative to the Cartesian coordinate system of FIGS. 10 and 11, the virtual space 1010 in which the viewing system 1000 hierarchically organizes the data objects to spatially relate to each other based on a physical paradigm can also be conceptualized as a node tree. FIGS. 12A-12C illustrate such a conceptualization. More particularly, FIG. 12A depicts a node tree 1200 that defines hierarchical relationships between the data nodes 1202a-1202h. FIG. 12B depicts a tree structure 1204 that provides potential visual display representations 1206a-1206h for each of the data objects 1202a-1202h. FIG. 12C provides a tree structure 1208 illustrative of how the user may navigate a displayed virtual representation 1206a-1206h of the data objects 1202a-1202h. The nodes of the node tree are representative of data objects and/or the appearance of those data objects.

FIG. 12C also illustrates one method by which the viewing system 1000 enables the user to navigate the data objects 1202a-1202h in an unrestricted manner. As indicated by the dashed connections 1210a-1210d, the viewing system 1000 enables the user to virtually pan across any data object on a common hierarchical level. By the way of example, the user may virtually navigate into a clothing store, graphically represented by the graphic appearance 1206a and then navigate to women's clothing represented by the graphic appearance 1206b. However, the viewing system 1000, based on a template related to a clothing store, has hierarchically organized men's clothing, represented by the graphic appearance 1206c, to be at an equivalent hierarchical location to women's clothing 1206b. Thus, the viewing system 1000 enables the user to pan visually from the women's clothing graphic appearance 1206b to the men's clothing graphic appearance 1206c, via the controls 1007, to view men's clothing.

FIG. 12C also illustrates how the viewing system 1000 enables the user to virtually travel through hierarchical levels. By way of example, and as indicated by the links 1212a-1212b, the user can virtually navigate from any data object, such as the object 1202a, assigned to a parent node in the tree structures 1200, 1204 and 1208, to any data object, such as objects 1202b and 1202c assigned to a child node in those tree structures. The viewing system 1000 also enables the user to navigate visually for example, from a hierarchically superior data object, such as the object 1202a, through data objects, such as the data object 1202c along the paths 1212b and 1212d to a hierarchically inferior data object, such as the data object 1202e. However, the motion displayed to the user is seemingly continuous, so that while virtually traveling through for example, the data object 1202c, the viewing system 1000 displays the graphic appearance 1206c as being larger with more detail and then, as disappearing from view as it moves to a virtual position behind the user's viewing position.

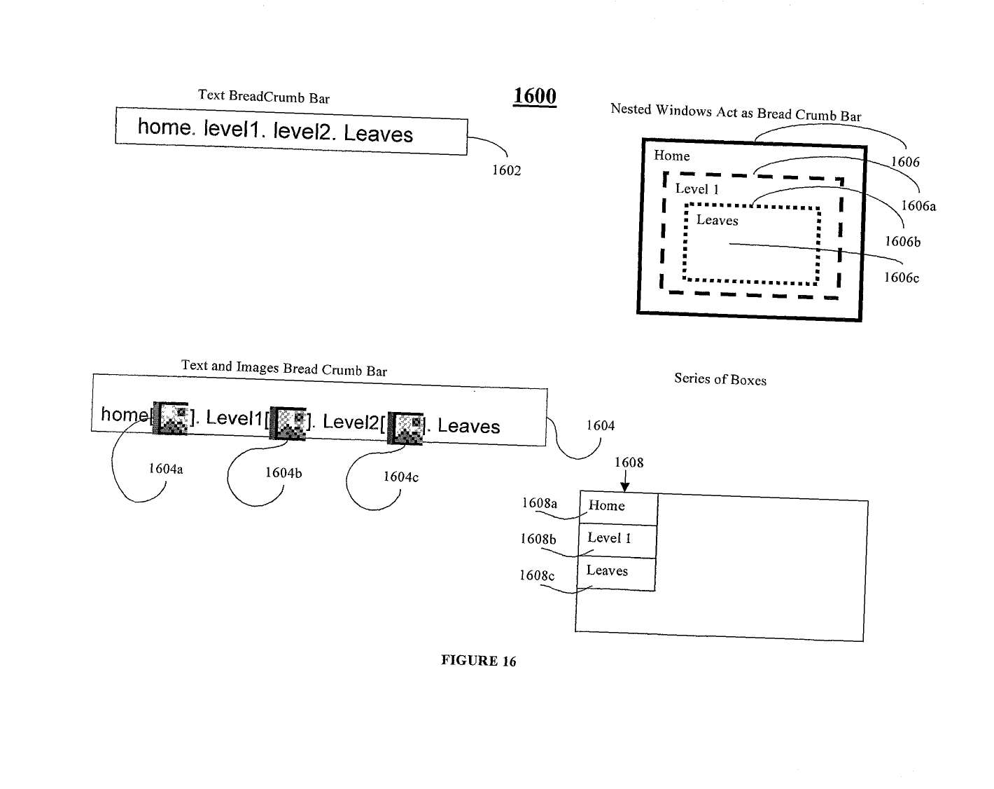

FIG. 12C also illustrates how the viewing system 1000 enables the user to navigate between data objects, without regard for hierarchical connections between the data objects 1202a-1202h. More particularly, as indicated by the illustrative paths 1214a and 1214b, the user can navigate directly between the data object 1202a and the data object 1202g. As described in detail below, with respect to FIGS. 16-18 the viewing system 1000 provides such unrestricted navigation using a variety of methods including by use of “wormholing,” “warping,” and search terms. In the node tree model of FIGS. 12A-12C, the viewing system 1000 displays a graphical representation of data objects to the user in a similar fashion to the coordinate-based system of FIGS. 10 and 11. More specifically, data objects located at nodes that are hierarchically closer to the user's virtual viewing position are displayed as being larger and with more detail than data objects located at nodes that are hierarchically farther away from the user's virtual viewing position. By way of example, in response to the user having a virtual viewing position indicated by the camera 1216b, the viewing system 1000 displays the graphic appearance 1206a to the user with greater detail and at a larger size than, for example, the graphic appearances 1206b-1206h. Similarly, the viewing system 1000 displays the graphic appearances 1206b and 1206c to the user with greater detail and at a larger size than it displays the graphic appearances 1206d-1206h. The viewing system 1000 employs a variety of methods for determining virtual distance for the purpose of providing a display to the user that is comparable to a physical paradigm, such as for example, the clothing store of FIGS. 12A-12C.

In the embodiment of FIG. 12A, the viewing system 1000 determines the user's virtual viewing position, indicated at 1216a. Then, the viewing system 1000 determines which data object 1202a-1202h is closest to the user's virtual position and defines a plurality of equidistant concentric radii 1218a-1218c extending from the closest data object, 1212c in the example of FIG. 12A. Since the data node 1202c is closest to the user's virtual position, the viewing system 1000 displays the data object 1202c with the most prominence (e.g., largest and most detailed). Alternatively, the data objects 1202a, 1202b, 1202d and 1202e, which are located equidistant from the data node 1202c are displayed similarly with respect to each other, but smaller and with less detail than the closest data node 1202c.

In another embodiment, the virtual distance calculation between nodes is also based on the hierarchical level of the data node that is closest to the user's virtual position. The nodes on the same hierarchical level are displayed as being the same size and with the same detail. Those nodes that are organized, hierarchically lower than the node closest to the user are displayed smaller and with less detail. Even though some nodes may be an equal radial distance with respect to the closest node, they may yet be assigned a greater virtual distance based on their hierarchical position in the tree 1200.

In a physical paradigm, such as the retail clothing store of FIGS. 12A-12C, the user is less likely to be interested in data objects located at nodes on the same hierarchical level. By way of example, the user browsing men's clothing at the node 1206c is more likely to navigate to men's pants at the node 1206e than to navigate to women's clothing at the node 1212a. Thus, in another embodiment, the viewing system 1000 includes the number of hierarchical links 1212a-1212g between nodes in the virtual distance calculation. For example, if the user's virtual location is at node 1206e (e.g., pants), the radial distance for nodes 1206d (e.g., shirts), 1206g (e.g., type of shirt) and 1206h (e.g., type of pants) may be equal. However, the calculated virtual distance to node 1206h (e.g., type of pants) is less then than the calculated virtual distance to nodes 1206d (e.g., shirts) and 1206g (e.g., type of shirt), since the node 1206h (e.g., type of pants) is only one link 1212g from the node 1206e (e.g., pants). Nodes separated by a single hierarchical link, such as the nodes 1206e and 1206h, are said to be directly related. The user is still able to freely travel to the less related nodes 1206d and 1206g in a straight line, so they are displayed. However the viewing system 1000 displays those nodes as being smaller and with less detail. When discussed in terms of the physical paradigm, the user is more likely to want to know about a type of pants 1206h when at the pants node 1206e than a type of shirt 1206g.

In another embodiment, the viewing system 1000 gives equal weight to the direct relationship basis and the same hierarchical level basis in the virtual distance calculation. With this method, the viewing system 1000 considers the nodes 1206d and 1206h to be an equal virtual distance from the node 1206e, and the node 1206g to be farther away from the node 1206e. Other embodiments may weight variables such as directness of relationship and hierarchical level differently when calculating virtual distance. Again, discussing in terms of the physical paradigm, the user may be equally interested in shirts 1206d or a type of pants 1206h when at the pants node 1206e. The viewing system 1000 assumes that the user is less likely to want to know about a type of shirt 1206g and thus, the viewing system 1000 sets the virtual distance greater for that node 1206g than the other two nodes 1206d, 1206h, even though the radial distance is equal for all three nodes 1206d, 1206g, 1206h.

In grouping hierarchically lower data nodes under a hierarchically higher data node, the viewing system 1000 conceptually drapes a grouping sheet over the hierarchically lower data nodes to form a category of data nodes. The viewing system 1000 then conceptually drapes larger grouping sheets over the first grouping sheets, thus grouping the data objects into greater categories. Such groupings are also evident in the hierarchical node structures of FIGS. 12A-12C.

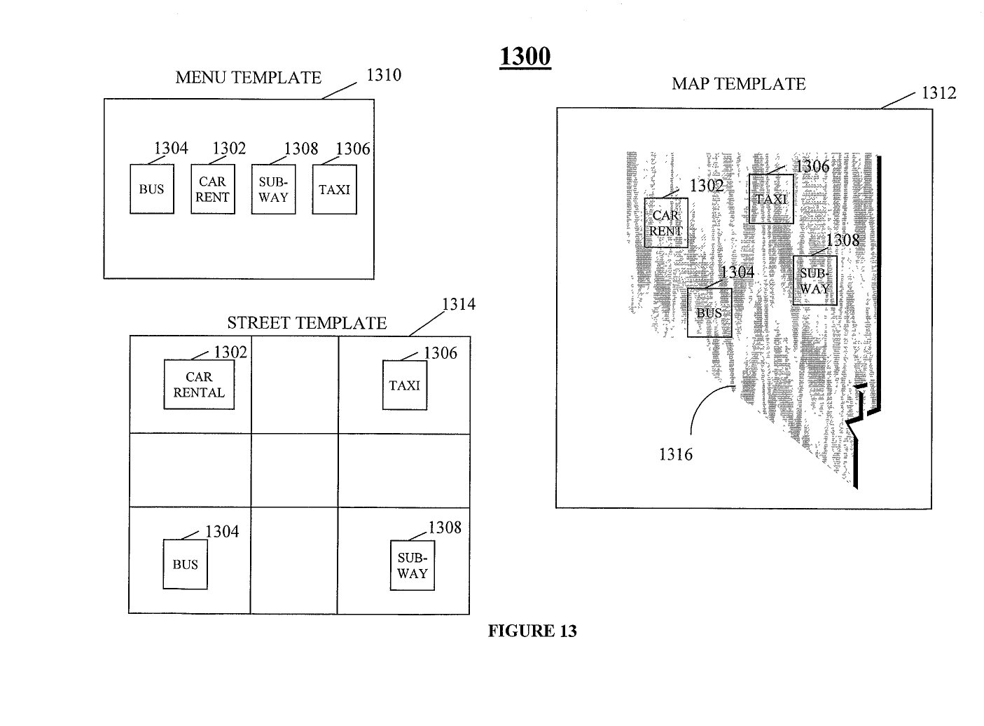

FIG. 13 depicts a block diagram 1300 illustrating the use of multiple templates in combination., In this illustration, four templates 1303, 1305, 1307 and 1309 represent four different transportation services; car rentals 1302, buses 1304, taxies 1306, and subways 1308. Illustratively, the bus 1304 and subway 1308 templates contain map and schedule information, and fares are based on the number of stops between which a rider travels. The taxi template 1306 has fare information based on mileage and can contain map information for calculating mileage and/or fares. The car rental template 1302 contains model/size information for various vehicles available for rent, and fares are based on time/duration of rental. The hierarchical layout for each template 1302-1308 is organized in accord with the invention to provide an intuitive virtual experience to the user navigating the information. As depicted in FIG. 13, the templates 1302-1308 can themselves be hierarchically organized (i.e., a top-level hierarchical relationship) through the use of the super templates 1310-1314. More specifically, in one example, the viewing system 1000 organizes the templates 1302-1308 using a menu super template 1310. The menu super template 1310 relates the templates 1302-1308 on a common hierarchical level, showing that all four transportation services 1302-1308 are available. Illustratively, the super template 1310 organizes the templates 1302-1308 alphabetically.

In another example, the viewing system 1000 organizes the templates 1302-1308 using a map super template 1312. The map super template 1312 relates to a geographical location physical paradigm. The map super template 1312 relates the four templates 1302-1308 in accordance with the geographical relationship between the represented transportation services (i.e. car rental, bus, taxi and subway). The map super template 1312 can be used, for example, when the user wants to know which transportation services are available at a particular geographical location. For example, the user may be trying to decide into which airport to fly in a certain state 1316, and wants to locate information about transportation services available at the different airports within the state.

In a further example, the viewing system 1000 organizes the templates 1304-1308 using a street super template 1314. The street super template 1314 relates to a street layout physical paradigm. The street super template 1314 spatially relates the templates 1304-1308 to each other in terms of their street location. The super template 1314 can be used, for example, when the user has a street address and wants to know which transportation services are available nearby. In a further embodiment, the user can begin with the map super template 1313 to find a general location and then pan and zoom to the street level using the street super template 1314.

The viewing system 1000 may additionally employ irregular display shapes for advanced visual recognition. For example, the graphic appearance associated with each data node can be defined to have a unique shape such as star, pentagon, square, triangle, or the like. With a conventional desktop metaphor, display area availability is at a premium, thus rendering it impractical to employ irregular shapes. However, the panning and zooming features of the viewing system 1000 render display space essentially infinite. Thus, the display of virtually any client can be configured in favor of readability and an overall user experience. An aspect of the illustrative viewing system 1000 provides the user with the sense of real-time control of the displayed data objects. Rather than a stop and go display/interactive experience, the viewing system 1000 provides an information flow, a revealing and folding away of information, as the user requires information. Accordingly, the state of the viewing system 1000 is a function of time. The user adjusts the virtual viewing position over time to go from one data object to the next. Therefore, a command for the virtual viewing position of the user, represented in FIGS. 10 and 11 by the position of the camera 1016, is of the form f(x, y, z), where (x, y, z) is a function of time, f(t). The appearance of data objects that the viewing system 1000 displays to the user is a function of time as well as position.

According to the illustrative embodiment, as the user changes viewing perspective, the viewing system 1000 changes the appearance of a graphical representation of the data objects in a smooth, continuous, physics-based motion. According to one embodiment, the motion between viewing perspective positions, whether panning (e.g., translational motion along the i and j axes of FIGS. 10 and 11) or zooming (e.g., motion along the k axis, with increasing detail of closest data objects), is performed smoothly. Preferably, the viewing system 1000 avoids generating discrete movements between locations. This helps ensure that the user experiences smooth, organic transitions of data object graphical appearances and maintains context of the relationship between proximal data objects in the virtual space, and between the displayed data objects and a particular physical paradigm being mimicked by the viewing system 1000.

In one embodiment, the viewing system 1000 applies a sine transformation to determine the appropriate display. For example, the virtual motion of the user can be described as linear change from t=0 to t=1. The viewing system 1000 applies a sine transform function to the discrete change, for example t_smooth=sin(t*pi/2) where t changes from 0 to 1. The discrete transition is changed to a smoother, rounded transition.

One way to model the motion for adjustments of the user viewing perspective is to analogize the user to a driver of a car. The car and driver have mass, so that any changes in motion are continuous, as the laws of physics dictate. The car can be accelerated with a gas pedal or decelerated with brakes. Shock absorbers keep the ride smooth. In terms of this model, the user controls 107 of system 100 are analogously equipped with these parts of the car, such as a virtual mass, virtual shocks, virtual pedals and a virtual steering wheel. The user's actions can be analogized to the driving of the car. When the user is actuating a control, such as a key, a joy stick, a touch-screen button, a voice command or a mouse button, this is analogous to actuating the car's accelerator. When the user deactuates the control and/or actuates an alternative control, this is analogous to releasing the accelerator and/or actuating the car's brakes. Thus, the illustrative viewing system 1000 models adjusting of the user viewing perspective as movement of the camera 1016. The system assigns a mass, a position, a velocity and an acceleration to the camera 1016.

In another embodiment, the viewing system 1000 models the user's virtual position logarithmically, that is, for every virtual step the user takes closer to a data object (e.g., zooms in), the viewing system 1000 displays to the user a power more detail of that data object. Similarly, for every virtual step the user takes farther away from a data object (e.g., zooms out), the viewing system 1000 displays to the user a power less detail for that data object. For example, the following illustrative code shows how exemplary expo and logo functions are used:

// returns the conversion factor of world width to screen width

| | |
|---|---|
| static | double world_screen_cfactor(double camera_z) |
| { | |
| | return exp(camera_z); |
| } | |

static double world_width_and_screen_width_to_camera_z(double
world_dx, int screen_dx)
{

| | |
|---|---|
| | if(world_dx==0) return 1; |
| | return log(((double)screen_dx)/world_dx); |
| } | |

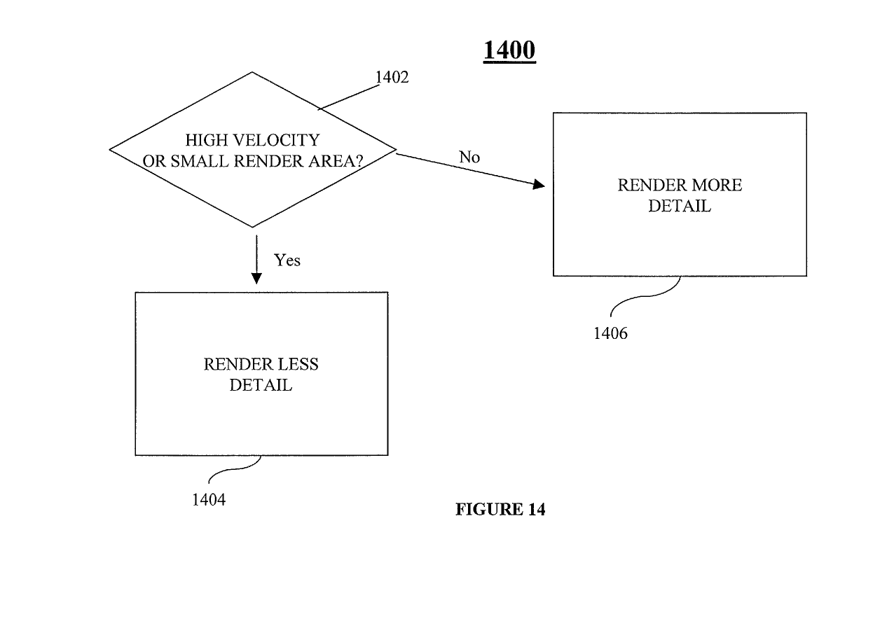

FIG. 14 provides a simplified flow diagram 1400 depicting operation of the viewing system 1000 when determining how much detail of a particular data object to render for the user. This decision process can be performed by a client, such as the client 1014 depicted in FIG. 19 or by the stylizer module 1004. As the decision block 1402 illustrates, the viewing system 1000 determines the virtual velocity of the change in the user's virtual position, and employs the virtual velocity as a factor in determining how much detail to render for the data objects. The viewing system 1000 also considers the display area available on the client to render the appearance of the data objects (e.g., screen size of client 1014). As indicated in steps 1402 and 1404, in response to determining that the virtual velocity is above one or more threshold levels, the viewing system 1000 renders successively less detail. Similarly, as also indicated by steps 1402 and 1404, the system 100 also renders less detail as the available display area at the client 1014 decreases. Alternatively, as indicated by steps 1402 and 1406, as the virtual velocity decreases and/or as the available display area at the client 1014 increases, the viewing system 1000 renders more detail. Thus, the viewing system 1000 makes efficient use of display area and avoids wasting time rendering unnecessary details for fast-moving data objects that appear to pass by the user quickly.

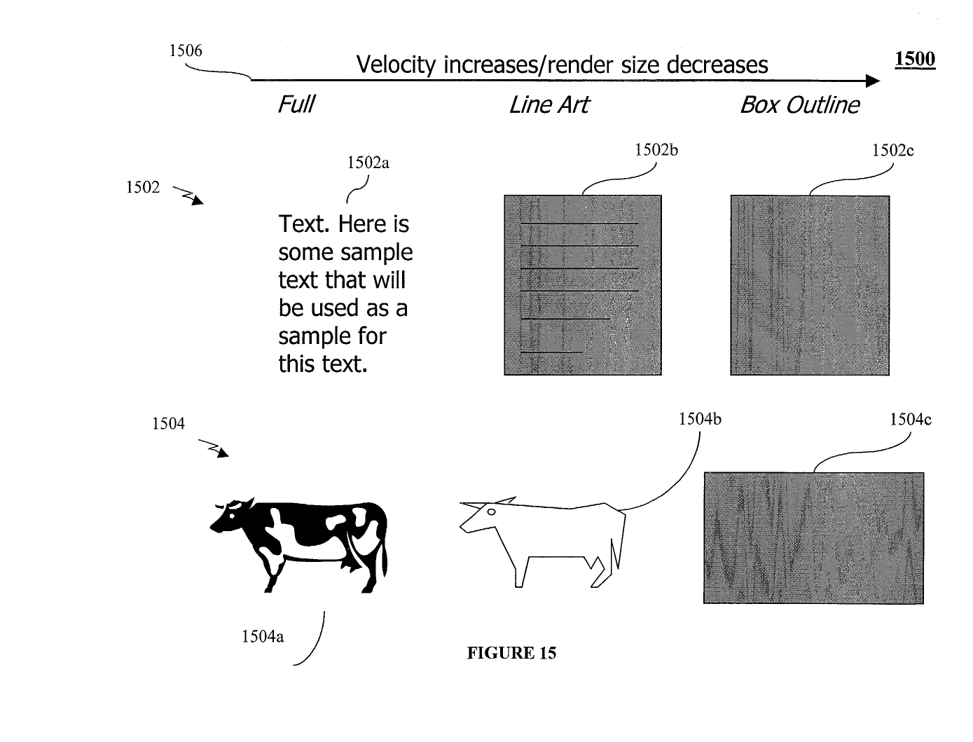

FIG. 15 illustrates various potential appearances 1502a-1502c for a textual data object 1502, along with various potential appearances 1504a-1504c for an image data object 1504. The axis 1506 indicates that as virtual velocity increases and/or as client display area decreases, the viewing system 1000 decreases the amount of detail in the appearance. At the “full” end of the axis 1506, the virtual velocity is the slowest and /or the client display area is the largest, and thus, the viewing system 1000 renders the textual data object 1502 and the image data object 1504 with relatively more detail, shown at 1502a and 1504a. At the “box outline” end of the axis 1506, the velocity is the greatest and /or the client display area is the smallest, and thus the viewing system 1000 renders the appearance of the same data objects 1502 and 1504 with no detail 1502c and 1504c, respectively. Instead, the viewing system 1000 renders the data objects 1502 and 1504 simply as boxes to represent to the user that a data object does exist at that point in the virtual space 1000, even though because of velocity or display area, the user cannot see the details. In the middle of the axis 1506 is the “line art” portion. In response to the virtual velocity and/or the available client display area being within particular parameters, the viewing system 1000 renders the data objects 1502 and 1504 as line drawings, such as that depicted at 1502b and 1504b, respectively.

In the illustrative embodiment, the viewing system 1000 transmits and stores images in two formats. The two formats are raster graphic appearances and vector graphic appearances. The trade-off between the two is that raster graphic appearances provide more detail while vector graphic appearances require less information. In one embodiment, raster graphic appearances are used to define the appearance of data objects. Raster graphic appearances defines graphic appearances by the bit. Since every bit is definable, raster graphic appearances enable the viewing system 1000 to display increased detail for each data object. However, since every bit is definable, a large amount of information is needed to define data objects that are rendered in a large client display area.

In another embodiment, the raster graphic appearances, which require large size data words even when compressed, are omitted and instead the viewing system 1000 employs vector graphic appearances and text, which require a smaller size data word than raster graphic appearances, to define the appearance of data objects. Vector graphic appearances define the appearance of data objects as coordinates of lines and shapes, using x, y coordinates. A rectangle can be defined with four x, y coordinates, instead of the x times y bits necessary to define the rectangle in a raster format. For example, the raster graphic appearance of the country of England, which is in gif form, highly compressed, is over three thousand bytes. However, the equivalent vector version is roughly seventy x, y points, where each x, y double is eight bytes for a total of five hundred sixty bytes. A delivery of text and vector images creates a real-time experience for users, even on a 14.4 kilobyte per second modem connection.

FIG. 16 illustrates various embodiments of visual indicators employed by the viewing system 1000. In addition to displaying data objects to the user, the viewing system 1000 also displays visual indicators to provide the user an indication of the hierarchical path the user has virtually navigated through in the virtual space 1008. This is sometimes referred to as a breadcrumb trail. In one embodiment, the viewing system 1000 provides a text breadcrumb bar 1602. The illustrative text breadcrumb bar 1602 is a line of text that concatenates each hierarchical level visited by the user. For example, referring back to FIG. 12, the graphic appearance 1206a is the “home” level, the graphic appearance 1206c is level 1, the graphic appearance 1206e is level 2 and, the graphic appearance 1206h is the “leaves” level. The associated text breadcrumb trail is thus, “store.mensclothing.menspants.” This represents the selections (e.g., plates, data nodes) that the user virtually traveled through (e.g., by way of zooming and panning) to arrive at the “leaves” level display.

According to another embodiment, the viewing system 1000 provides a text and image bread crumb bar 1604. Like the text breadcrumb trail 1602, the text and image breadcrumb trail 1604 is a concatenation of each hierarchical level through which the user virtually travels. However, in addition to text, the trail 1604 also includes thumbnail images 1604a-1604c to give the user a further visual indication of the contents of each hierarchical level. In another embodiment, the viewing system 1000 provides a trail of nested screens 1606. Each nested screen 1606a-1606c corresponds to a hierarchical level navigated through by the user. In another embodiment, the viewing system 1000 provides a series of boxes 1608 in a portion of the display. Each box 1608a-1608c represents a hierarchical level that the user has navigated through and can include, for example, mini screen shots (e.g., vector condensation), text and/or icons. According to a further feature, selecting any particular hierarchical level on a breadcrumb trail causes the user to automatically virtually navigate to the selected hierarchical level.

According to another feature, the viewing system 1000 enables the user to preview data objects without having to zoom to them. According to one embodiment, in response to the user moving a cursor over a region of the display, the viewing system 1000 reveals more detail about the data object(s) over which the cursor resides. By way of example, referring to the plates 1104a -1104c of FIG. 11, in response to the user placing the cursor in a particular location, the viewing system 1000 displays data objects on one or more plates behind the plate in current view. The term “fisheye” refers to a region, illustratively circular, in the display that acts conceptually as a magnified zoom lens. According to a fisheye feature, the viewing system 1000 expands and shows more detail of the appearance of the data objects within the fisheye region. In one embodiment, these concepts are used in combination with a breadcrumb trail. For example, in response to the user locating the cursor or moving the “fisheye” on a particular hierarchical level of a breadcrumb trail the viewing system 1000 displays the contents of that particular hierarchical level. According to one embodiment, the viewing system 1000 displays such contents via a text information bar. Thus, these functions enable the user to preview a data object on a different hierarchical level, without actually having to change the viewing perspective to that level, and to make enhanced usage of the breadcrumb trails illustrated in FIG. 16.

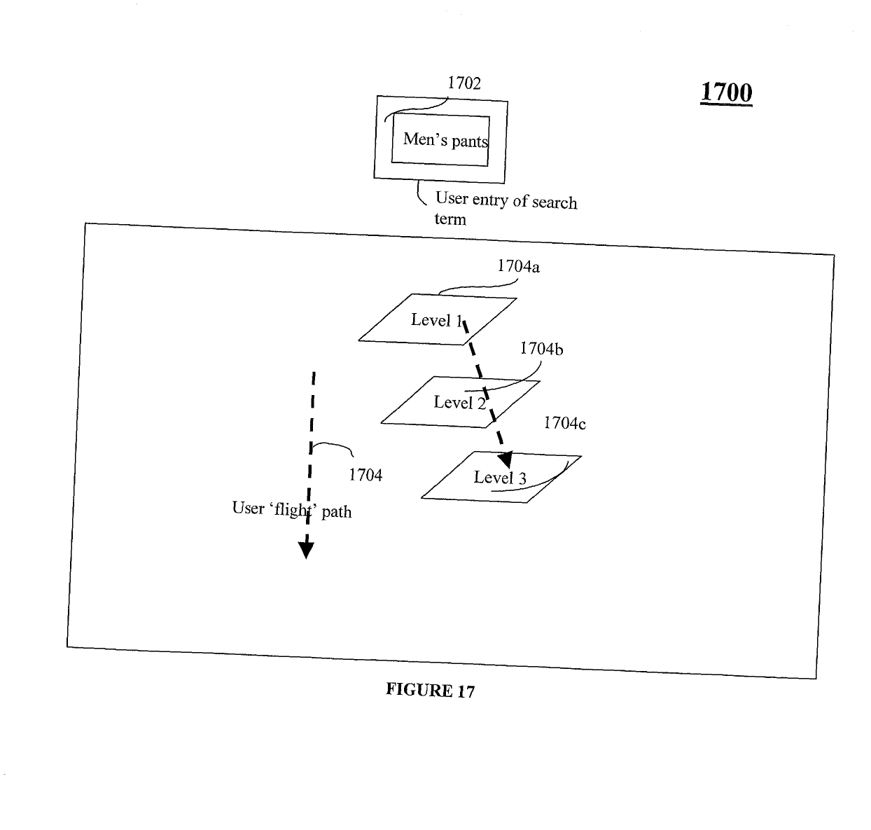

FIG. 17 provides a conceptual diagram 1700 illustrating two methods by which the user can virtually navigate to any available data object, or hierarchical level. The two illustrative methods are “warping” and search terms. An exemplary use of search terms and warping is as follows. Referring also back to FIG. 12A-12C, from the home graphic appearance 1206a, the user can input a search term, such as “menspants” 1702. In response, the viewing system 1000 automatically changes the user's virtual location (and thus, hierarchical level), and displays the graphic appearance 1206e, whereby the user can zoom into any of the graphic appearance 1206h to reveal available products 1206h. As illustrated by the user ‘flight’ path 1706, the virtual motion of the viewing perspective is a seemingly continuous motion from a starting hierarchical level 1704a at the data object graphic appearance 1206a to the hierarchical level 1704c of the data object graphic appearance 1206e corresponding to the entered search term 1704b. As the user virtually travels through the intermediate hierarchical levels 1704b associated with the data object 1206c the viewing system 1000 also renders the data objects that are virtually and/or hierarchically proximate to the intermediate data object 1206c. This provides the user with an experience comparable of traveling through the virtual, multi-dimensional space 1010 in which the data objects are located. However, very little detail is used, as the velocity of the automatic change of location of the viewing perspective is very fast.

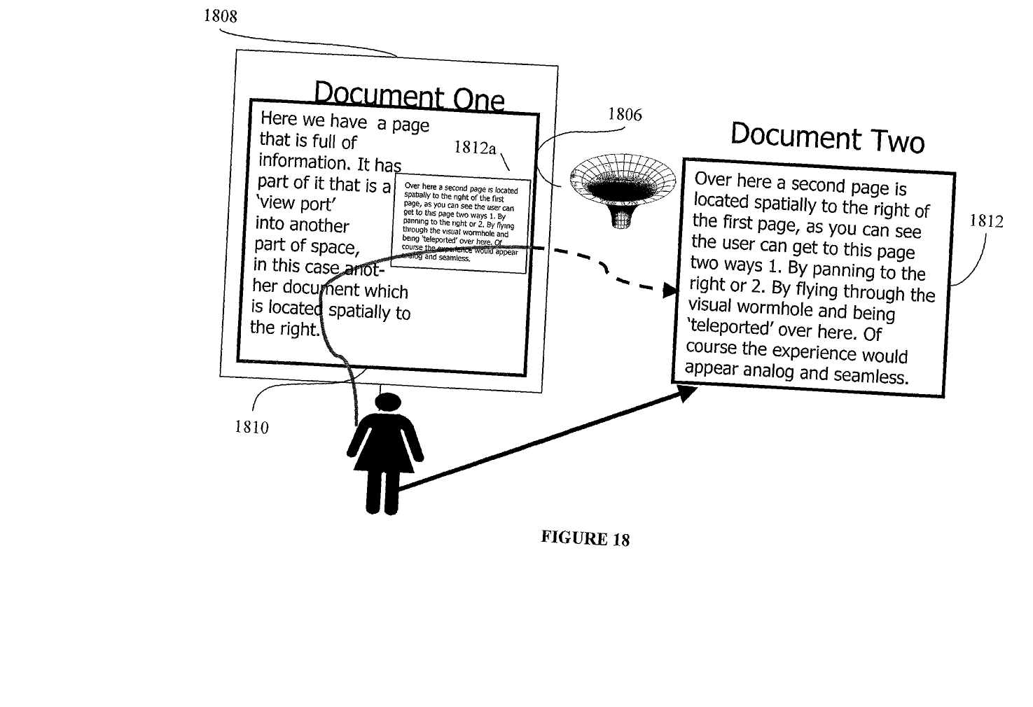

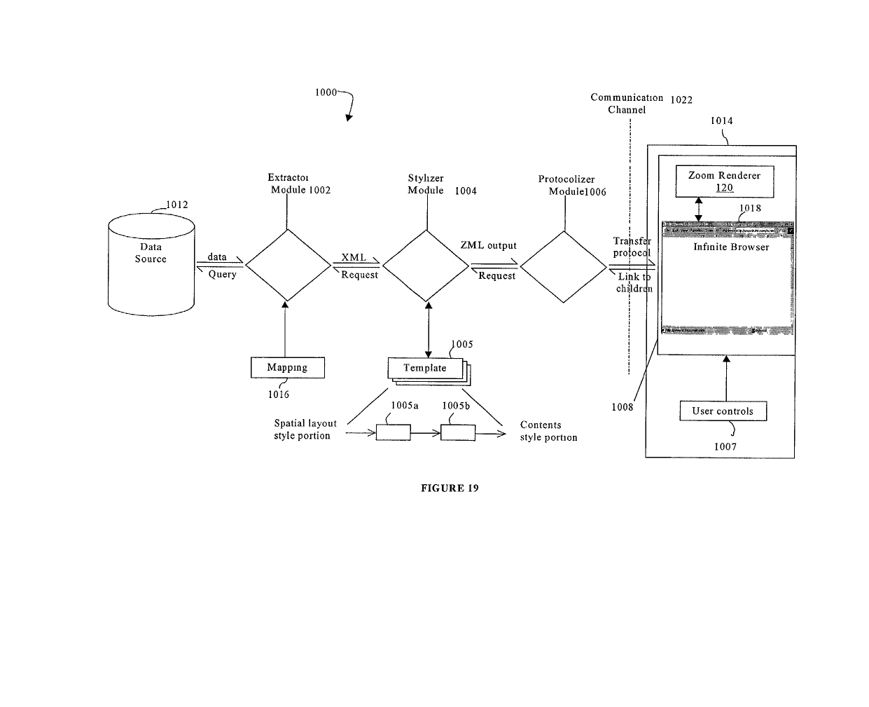

According to another embodiment, the viewing system 1000 enables the user to warp from one data object to another through the use of a visual “wormhole.” FIG. 18 illustrates the use of a wormhole 1806 within the graphic appearance 1808. In the graphic appearance 1808, there are two data objects identified, the document 1810 and a reduced version 1812a of a document 1812. In the spatial hierarchical relationship in the virtual space 1010, the document 1808 is located virtually far away from the document 1812. However, the template 1005 provides a connection (e.g., a hyperlink) between the two documents 1810 and 1812. In response, the viewing system 1000 creates a wormhole 1806. Since a wormhole exists, the viewing system 1000 displays the reduced version 1812a (e.g., thumbnail) of the data object graphic appearance associated with the document 1812 within document 1808 to indicate to the user that the wormhole (e.g., hyperlink) exists. In response to the user selecting the data object 1812a, the viewing system 1000 warps the user to the data object 1812. As described above with respect to FIG. 17, when warping, the viewing system 1000 displays to the user a continuous, virtual motion through all of the existing data objects between the document 1808 and the document 1812. However, the virtual path is direct and the user does not navigate, the viewing system 1000 automatically changes the user's viewing perspective. Of course, the user is always free to navigate to the document 1812 manually. Illustratively, warping is employed to provide the automatic breadcrumb navigation discussed above with respect to FIG. 16.

FIG. 19 is a schematic view depicting another exemplary implementation of the viewing system 1000. As discussed with respect to FIG. 10, the viewing system 1000 includes an extractor module 1002, a stylizer module 1004, a protocolizer module 1006, one or more templates 1005, user controls 1007 and a display 1008. FIG. 12 depicts each component 1002, 1004, 1005, 1006, 1007 and 1008 as individual components for illustrative clarity. However, actual physical location can vary, dependent on the software and/or hardware used to implement the viewing system 1000. In one embodiment, for example, the components 1002, 1004, 1005 and 1006 reside on a server (not shown) and components 1007 and 1008 reside on a client 1014. In another embodiment, for example, all of the components 1002, 1004, 1006, 1007 and 1008 reside on a personal computer.

The extractor module 1002 is in communication with a data source 1012 (e.g., a database) from which the extractor module 1002 extracts data objects. The extractor module 1002 converts, if necessary, the data objects into a W3C standard language format (e.g., extended markup language “XML™”). The extractor module 1002 uses a mapping module 1016 to relate each of the data objects to each of the other data objects. In one embodiment, the mapping module 1016 is an internal sub-process of the extractor module 1002. The extractor module 1002 is also in communication with the stylizer module 1004. The extractor module 1002 transmits the data objects to the stylizer module 1004.

The stylizer module 1004 converts the data objects from their W3C standard language format (e.g., XML™) into a virtual space language format (e.g., ZML™, SZML™, referred to generally as ZML™). The ZML™ format enables the user to view the data objects from an adjustable viewing perspective in the multi-dimensional, virtual space 1010, instead of the two-dimensional viewing perspective of a typical Web page. The stylizer module 1004 uses one or more templates 1005 to aid in the conversion. The one or more templates, 1005 hereinafter referred to as the template 1005 include two sub-portions, a spatial layout style portion 1005a and a content style portion 1005b. The spatial layout style portion 1005a relates the data objects in a hierarchical fashion according a physical paradigm. The contents style portion 1005b defines how the data object are rendered to the user. The stylizer module 1004 is also in communication with the protocolizer module 1006. The stylizer module 1004 transmits the data objects, now in ZML™ format, to the protocolizer module 1006.

The protocolizer module 1006 converts the data objects to established protocols (e.g., WAP, HTML, GIF, Macromedia FLASH™) to communicate with a plurality of available clients 1014 (e.g., televisions; personal computers; laptop computers; wearable computers; personal digital assistants; wireless telephones; kiosks; key chain displays; watch displays; touch screens; aircraft; watercraft; and/or automotive displays) and browsers 1018 (e.g., Microsoft Internet Explorer™, Netscape Navigator™) to display the data objects from the user's viewing perspective in a navigable, multi-dimensional virtual space 1010. The browser 1018 is hardware and/or software for navigating, viewing and interacting with local and/or remote information. The viewing system 1000 also includes a zoom renderer 1020. The zoom renderer 1020 is software that renders the graphic appearances to the user. This can be, for example, a stand-alone component or a plug-in to the browser 1018, if the browser 1018 does not have the capability to display the ZML™ formatted data objects. Throughout the specification, the term “client” 1014 is used to represent both the hardware and the software needed to view information although the hardware is not necessarily considered part of the viewing system 1000. The protocolizer module 1006 communicates with the client 1014 via a communication channel 1022. Since the protocolizer module 1006 converts the ZML™ format into an established protocol, the communication channel 1022 can be any channel supporting the protocol to which the protocolizer module 106 converts the ZML™ format. For example, the communication channel 1022 can be a LAN, WAN, intranet, Internet, cellular telephone network, wireless communication network (including third generation wireless devices), infrared radiation (“IR”) communication channel, PDA cradle, cable television network, satellite television network, and the like.

The data source 1012, at the beginning of the process, provides the content (i.e., data objects). The content of the data source 1012 can be of any type. For example, the content can take the form of a legacy database (e.g., Oracle™, Sybase™, Microsoft Excel™, Microsoft Access™), a live information feed, a substantially real-time data source and/or an operating system file structure (e.g., MAC™ OS, UNIX™ and variations of UNIX™, Microsoft™ Windows™ and variations of Windows™). In another embodiment, the data source 112 can be a Web server and the content can include, for example, an HTML page, a page written in Coldfusion™ Markup Language (“CFM”) by Allaire, an Active Server Page (“ASP”) and/or a page written for a Macromedia FLASH™ player. In these cases, the content typically is not stored in the ZML™ format (i.e., “zoom-enabled”). If the content is not stored in a ZML™ format, the extractor module 1002 and stylizer module 1004 convert the content into the ZML™ format. In another embodiment, the content can be one or more of an algorithm, a simulation, a model, a file, and a storage device.

In other embodiments, the stored content is in the ZML™ format. In these embodiments, the viewing system 1000 transfers the content from the data source 1012 to the extractor module 1002, the stylizer module 1004 and protocolizer module 1006, without any additional processing. For example, if the content of the data source 1012 is already in ZML™ format, the stylizer module 1004 does not need to take any action and can transmit the content directly to the protocolizer module 1006.

The types of transactions processed by the data source 1012 are transactions for obtaining the desired content. For example, for a legacy database, a representative input can be “get record” and the corresponding output is the requested record itself. For a file system, a representative input can be “get file(dir)” and the corresponding output is the content information of the “file/dir.” For a Web site, a representative input can be “get page/part” and the corresponding output is the requested page/part itself. The viewing system 1000 transfers the output from the data source 1012 to the extractor module 1002.

As briefly mentioned above, the extractor module 1002 receives the content from the data source 1012. The extractor module 1002 separates the content into pieces referred to as data objects. The extractor module 1002 converts the content into a hierarchical relationship between the data objects within the content. In one embodiment, the hierarchical data structure is one that follows a common language standard (e.g., XML™).

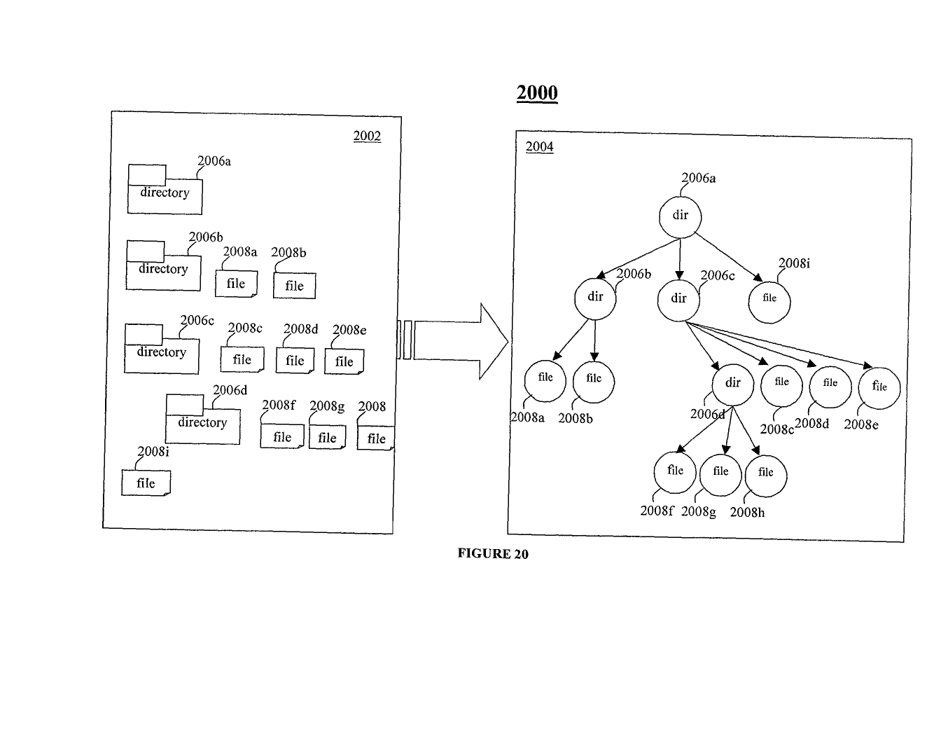

FIG. 20 is a schematic view 2000 depicting an illustrative conversion of a file system directory tree 2002 to a hierarchical structure 2004 of data objects by the extractor module 1002. The extractor module 1012 relates each of the data objects, consisting of the directories 2006a-2006d and the files 2008a-2008c, to each other in the hierarchical data structure 2004, illustratively represented as a node tree. In this embodiment, relationships between the nodes 2006a-2006d and 2008a-2008h of the hierarchical data structure 2004 follow the relationships depicted in the directory tree 2002.

The types of transactions processed by the extractor module 1002 are transactions for converting the obtained content to data objects in a hierarchical data structure, for example, XML™. For example, for a legacy database, representative inputs to the extractor module 1002 can be data record numbers and mapping, if the data base already contains a mapping of the data objects. A representative command can be, for example, “get_record(name)|get_record(index).” The corresponding output from the extractor module 102 is an XML™ data structure of the data objects. For a file system, for example, a representative input can be filename(s), with representative commands such as “get_file(directory, name)” and “get_file_listing(directory).” For a Web site, a representative input can be Web pages/parts, with a representative command such as “get_WEb_content(URL, start tag, end tag).” By way of further example, the extractor module 1002 analyzes the content to convert the content to create an exemplary structure such as:

| | |
|---|---|
| struct | |
| { | |
| | void* data... |
| | node* parent |
| | node* child[ren] |
| }node; | |

As mentioned above, to create the exemplary structure, the illustrative extractor module 1002 uses the mapping module 1016. Operation of the mapping module 1016 depends on the type of content received by the extractor module 1002. For example, for a file structure, the mapping module 1016 traverses the directory tree until it creates a node for each file (i.e., data object) and each directory (i.e., data object) and creates the appropriate parent-child relationship between the nodes (i.e., data objects). FIG. 20 illustrates how the mapping module 1016 follows the directory tree 2002 when creating the hierarchical data structure 2004. For some databases, the mapping module 1016 keeps the hierarchical relationships of data objects as they are in the data source. For example, a retail store might organize its contents in, for example, an Oracle™ database and into logical categories and sub-categories forming a hierarchical data structure that the mapping module 1016 can copy. Another database might be, for example, a list of geographic points. The mapping module 1016 can use geographical relationship to create the hierarchical relationship between the points.

In other databases, there are no hierarchical relationships between data objects. In that case, the mapping module 1016 creates them. In other data bases, such as for example, a flat list of names and personal information, the hierarchical structure may be less evident. In that case, the mapping module 1016, preferably, creates the relationships using some predetermined priorities (e.g., parent nodes are state of residence first, then letters of the alphabet).

If the content is Web-related content, the mapping module 1016 extracts the vital information by first determining the flow or order of the Web site. To zoom enable a typical Web site, the mapping module 1016 extracts from the Web site a data hierarchy. HTML pages are a mix of data and formatting instructions for that data. HTML pages also include links to data, which may be on the same page or a different page. In one embodiment, the mapping module 1016 “crawls” a Web site and identifies a “home” data node (for example, on the home page) and the name of the company or service. Next, the mapping module 1016 identifies the primary components of the service such as, for example, a table of contents, along with the main features such as “order,” “contact us,” “registration,” “about us,” and the like. Then the mapping module 1016 recursively works through the sub-sections and sub-subsections, until it reaches “leaf nodes” which are products, services, or nuggets of information (i.e., ends of the node tree branches).

This process determines critical data and pathways, stripping away non-essential data and creating a hierarchical tree to bind the primary content. This stripping down creates a framework suitable for zooming, provides the user with a more meaningful focused experience, and reduces strain on the client/server connection bandwidth.

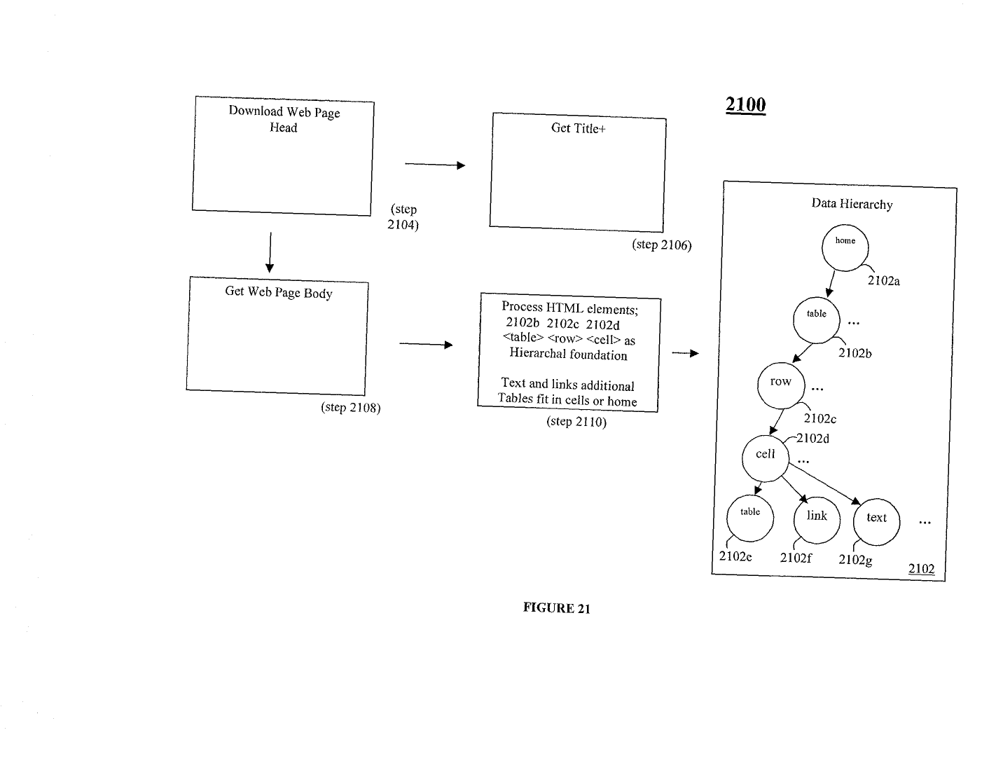

FIG. 21 is a flow diagram 2100 illustrating operation of an exemplary embodiment of the extractor module 1002 process for converting a Web page to a hierarchical XML™ data structure 2102. The extractor module 1002 downloads (step 2104) the Web page (e.g., HTML document). From the contents between the Web page <head> </head> tags, the mapping module 1016 obtains (step 2106) the title and URL information and uses this information as the home node 2102a (i.e., the root node). The extractor module 1002 also obtains (step 2108) the contents between the Web page <body> </body> tags. The mapping module 1016 processes (step 2110) the HTML elements (e.g., 2102b-2102c) to create the hierarchical structure 2102. For example, as shown, the first HTML element encountered is a table 2102b. The table 2102b includes a first row 2102c. The first row 2102c includes a first cell 2102d. The first cell 2102d includes a table 2102e, a link 2102f and some text 2102g. As the mapping module 1016 traverses (step 2110) the HTML elements, it forms the hierarchical structure 2102. Any traversal algorithm can be used. For example, the mapping module 1016 can proceed, after obtaining all of the contents 2102e-2102g of the first cell 2102d of the first row 2102c, to a second cell (not shown) of the first row 2102c. This traversal is repeated until all of the HTML elements of the Web page have been processed (step 2110) and mapped into the hierarchical structure 2102.

In another embodiment, the extractor module 1002 extracts each displayable element from a Web page. Each element becomes a data object. The mapping module 1016, preferably, creates a hierarchical relationship between the data objects based on the value of the font size of the element. The mapping module 1016 positions those data objects (e.g., HTML elements) with a larger value font size higher in the hierarchical relationship than those data objects with a smaller value font size. Additionally, the mapping module 1016, preferably, uses the location of each element in the Web page as a factor in creating the hierarchical relationship. More particularly, the mapping module 1016 locates those elements that are next to each other on the Web page, near each other in the hierarchical relationship.

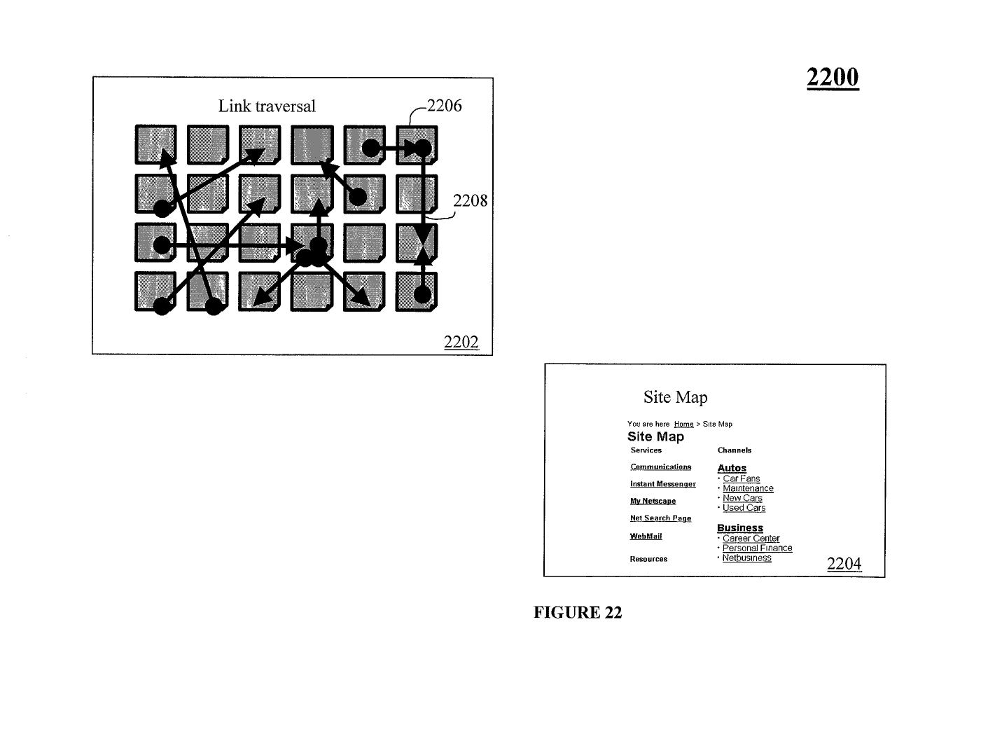

In another embodiment, to further help extract the vital information from Web sites, the mapping module 1016 uses techniques such as traversing the hyperlinks, the site index, the most popular paths traveled and/or the site toolbar, and parsing the URL. FIG. 22 is a diagram 2200 illustrating two of these techniques; traversing the hyperlinks 2202 and the site index 2204. In the illustrative example, the mapping module 1016 traverses the hyperlinks 2202 to help create a hierarchy. During this process, the mapping module 1016 tracks how each page 2206 relates to each link 2208, and essentially maps a spider web of pages 2206 and links 2208, from which the mapping module 1016 creates a hierarchy. The mapping module 1016 can also use the site map 2204 and tool bars when those constructs reveal the structure of a Web site. As discussed above, the mapping module 1016 can also use the size of the font of the elements of the site map 2204 along with their relative position to each other to create a hierarchy.

Additionally, the mapping module 1016 can parse the URL to obtain information about the Web site. Typically, URLs are in the form http://www.name.com/dir1dir2/file.html. The name.com field generally indicates the name of the organization and the type of the organization (.com company, .cr for Costa Rica, .edu for education and the like). The dir1 and dir2 fields provide hierarchical information. The file.html field can also reveal some information, if the file name is descriptive in nature, about the contents of the file.

The mapping module 1016 can also access information from Web sites that track the popularity of URL paths traveled. Such sites track which links and pages are visited most often, and weights paths based on the number of times they are traversed. The illustrative mapping module 1016 uses the information obtained from such sites, alone or in combination with other relationship information gained with other techniques, to create the hierarchical relationships between extracted data objects.

Once the mapping module 1016, working in conjunction with the extractor module 1002, creates a hierarchical data structure for the extracted data objects, the extractor module 1002 processes the data objects of the content in terms of their relationship in the hierarchy. In one embodiment, a W3C standard language data structure (e.g. XML™) is used to create a platform and vendor independent data warehouse, so that the rest of the system 100 can read the source content and relate the data objects of the content in the virtual space 1010.

The types of transactions processed by the extractor module 1002 are transactions relating to obtaining the hierarchical relationships between data objects. For example, for node information, a representative input can be “get node[x]” and the corresponding output is the requested node[x] itself. For data information, a representative input can be “get data” and the corresponding output is the requested data itself. For parent information, a representative input can be “get parent” and the corresponding output is the requested parent itself. For child information, a representative input can be “get child[x]” and the corresponding output is the requested child[x] itself. The extractor module 1002 provides the output (i.e., the XML™ data structure) to the stylizer module 1004.

As mentioned briefly above, the stylizer module 1004 converts the data objects from the extractor module 1002 into ZML™ format. The stylizer module uses one or more templates 1005, which are related to one or more physical paradigms, to aid in the conversion. The template 1005 includes two sub-portions, the spatial layout style portion 1005a and the contents style portion 1005b. The spatial layout style portion 1005a relates the data objects in a hierarchical fashion according to a physical paradigm. The contents style portion 1005b defines how the data objects are rendered to the user.

The stylizer module 1004 can be implemented using any of a plurality of languages, including but not limited to JAVA™, C, XML™ related software, layout algorithms, GUI-based programs, and C and Macromedia FLASH™ compatible programs. The stylizer module 1004 receives data objects from the extractor module 1002 and converts the data objects from an XML™ format to the ZML™ format. The ZML™ format generated by the stylizer 1004 is analogous to HTML, except designed for the multi-dimensional virtual space 1010. The ZML™ format employs a mark up language that describes one or more of the data objects organized within the virtual space. Like HTML, ZML™ format uses tags to describe the attributes of, for example, the conceptual plates 1104a-1104c discussed above with respect to FIG. 11. Illustratively:

| <Tags> | Attributes |
|---|---|
| <plate> | x, y, z, width, height, depth |
| <raster> | URL |
| <vector> | URL |
| <text> | font, size, justify |
| <link> | URL |

The stylizer module 1006 uses one or more templates 1005 to generate ZML™ formatted data objects. As discussed above, templates describe how data objects from a data source are arranged in the multi-dimensional virtual space 1010. Templates include a plurality of properties relating to a physical paradigm.

The following list contains some exemplary properties of a template relating to a financial paradigm. Specifically, the list of properties is for a section of the template 1005 for viewing a stock quote including historical data, news headlines and full text.

p=parent
j=justify
n=name
ab=all_borders
cx=children_x
bb=bottom_border
tb=top_border
lb=left_border
rb=right_border
cb=cell_border
fow=fade_out_on_width
fiw=fade_in_on_width
zt=zoom_to
bt=border_thickness
t=title
lbi=left_border_internal
rbi=right_border_internal
w=wrap
pv=plot_val
pyl=plot_y_label
pmx=plot_min _x
pxx=plot_max_x
pmy=plot_min_y
pxy=plot_max_y

Each property in the list is limited to a few letters to save memory for use in handheld devices and/or other low capacity (e.g. bandwidth, processor and/or memory limited) devices.

The template properties listed above describe characteristics of the information relating to the exemplary financial paradigm and displayed to the user in the virtual space 1010. Some properties describe visibility. For example, the fade properties describe when the appearance of data objects on a hierarchical plate comes within the viewing perspective (e.g., becomes visible to the user). Properties can also describe the appearance of included text. For example, some properties describe how the text appears, whether the text is wrapped, how the text is justified and/or whether the text is inverted. Properties can also describe dimensions of the data objects on the plate. For example, some properties describe whether the data object of the focus node has any borders and/or how the data objects corresponding to any children nodes are arranged. Properties can further describe the appearance of the data object on the hierarchical plate. For example, some properties describe whether the hierarchical plate contains charts and/or maps and/or images.

Templates also contain a plurality of placeholders for input variables. The following list includes illustrative input variables for the exemplary financial template. The input variables describe parameters, such as high price, low price, volume, history, plots and labels, news headlines, details, and the like.

| | |
|---|---|
| $q$ | (name) |
| $s_td$ | (last) |
| $o_td$ | (open) |
| $v_td$ | (volume) |
| $h_td$ | (high) |
| $1_td$ | (low) |
| $c_td$ | (change) |
| $b_td$ | (bid) |
| $a_td$ | (ask) |
| $pv_td$ | (today's prices) |
| $pmx_3m$ | (3 month t0) |
| $pxx_3m$ | (3 month t1) |
| $h_3m$ | (3 month price high) |
| $1_3m$ | (3 month price low) |
| $pv_3m$ | (3 month prices) |
| $pmx_3m$ | (6 month t0) |
| $pxx_3m$ | (6 month t1) |
| $h_3m$ | (6 month price high) |
| $1_3m$ | (6 month price low) |
| $pv_3m$ | (6 month prices) |
| $pmx_1y$ | (1 year t0) |
| $pxx_1y$ | (1 year t1) |
| $h_1y$ | (1 year price high) |
| $1_1y$ | (1 year price low) |
| $pv_1y$ | (1 year prices) |
| $pmx_5y$ | (5 year t0) |
| $pxx_5y$ | (5 year t1) |
| $h5_y$ | (5 year price high) |
| $15_y$ | (5 year price low) |
| $pv_5y$ | (5 year prices) |
| $nzh1$ | (new headline 1) |
| $nzh2$ | (new headline 2) |
| $nzh3$ | (new headline 3) |
| $nzd1$ | (new detail 1) |
| $nzd2$ | (new detail 2) |
| $nzd3$ | (new detail 3) |

The SZML™ format is similar to ZML™ format, except instead of plates, the SZML™ format describes attributes of the appearance in terms of a screen display. The SZML™ format is the ZML™ format processed and optimized for display on a reduced sized screen. One advantage of the SZML™ format is that when zooming and panning, the user tends to focus on certain screen-size quantities of information, regardless of what level of abstraction the user is viewing. In other words, when the user wants to look at something, the user wants it to be the full screen. For example, in a calendar program the user may want to concentrate on a day, a week, or a year. The user wants the screen to be at the level on which the user wants to concentrate.

The SZML™ format is vector based. Vector graphic appearances enable the appearance of data objects to be transmitted and displayed quickly and with little resources. Using the SZML™ format gives the user a viewing experience like they are looking at a true three dimensional ZML™ formatted environment, while in reality the user is navigating a graphical presentation optimized for a reduced size, two-dimensional display. In the illustrative embodiment, the SZML™ format provides the content author ultimate and explicit control of what the appearance user sees on the screen. In the illustrative embodiment, the SZML™ format is based on ‘Screens’ described by a series of vector graphic appearance elements such as rectangles, text, axes, and polygons. The SZML™ elements are described by a mark-up language, and as such, uses tags to describe attributes. For example:

| | |
|---|---|
| <text> | title=$str$ |
| | justify=int |
| | wrap=int |
| | format=int |
| <axes> | x_label=$str$ |
| | x_low=$str$ |
| | x_high=$str$ |
| | y_label=$str$ |
| | y_low=$str$ |
| | y_high=$str$ |
| <polygon> | points=$int$ |
| | values=‘$int$,$int$ $int$,$int$ $int$,$int$ ....’ //$int$=0...99 |
| <void> | |
| <rect> | coordinates=‘$int$,$int$ $int$,$int$ $int$,$int$ $int$,$int$’ |
| <*all*> | name=$str$ |
| | zoom_to=$str$ |
| | coordinates=‘$int$,$int$ $int$,$int$ $int$,$int$ $int$,$int$’ |

The <*all*> tag is not a separate tag, but shows attributes for each element, regardless of the type of the element. Each element has a name, rectangular bounds, and potentially a ‘zoom to’ attribute, which when clicked will transport the user to another screen.

To increase the speed at which the data is transmitted, to decrease the bandwidth requirements, and to decrease the storage capacity needed, the SZML™ tags can be reduced to one or two characters. The attributes listed above, for example, can be reduced as follows:

| | | | | |
|---|---|---|---|---|
| T = | text | t | = | title |
| | | j | = | justify |
| | | f | = | format |
| | | w | = | wrap mode |
| A = | axes | x | = | x_label |
| | | xl | = | x_low |
| | | xh | = | x_high |
| | | y | = | y_label |
| | | yl | = | y_low |
| | | yh | = | y_high |
| P = | Polygon | s | = | points |
| | | v | = | values |
| R = | rect | c | = | coordinates |
| All | | | | |
| | | n | = | name |
| | | z | = | zoom_to |
| | | c | = | coordinates |

To further improve data transmission, SZML™ formatted text may be compressed before transmission and decompressed after reception. Any known compression/decompression algorithms suffice.

The SZML™ format stores and relates data objects as screens, and stores a plurality of full screens in memory. In SZML™ formatted information, each screen has travel regions (e.g. ‘click-regions’) which are ‘zoom-links’ to other screens. When the user clicks on the ‘click region’, the viewing perspective zooms from the currently viewed screen to the “zoom_to” screen indicated in the attributes of the screen. For zooming, in one embodiment, screens can be thought of as containing three states; small (e.g., 25% of normal display), normal (e.g., 100% ) and large (e.g., 400% of normal display).

When zooming in, the focus screen (e.g., the screen currently being displayed) transitions from normal to large (e.g., from 100% of normal display to 400% of normal display). Subsequently, approximately when the ‘click region’ reaches its small state (e.g., 25% of normal display), the “zoom-to” screen is displayed and transitions from small to normal (e.g., 25% of normal display to 100% of normal display). Subsequently, approximately when the focus screen reaches its large state and prior to the clicked screen reaching its normal state, the focus screen is no longer displayed in the appearance. This gives the appearance to the user of zooming into the ‘click region’ (which expands) through the focus screen (which also expands). Illustratively, the expansion is linear, but this need not be the case.

When zooming out, the focus screen (e.g., the screen currently being displayed) transitions from normal to small (e.g., from 100% of normal display to 25% of normal display). Subsequently, the parent screen transitions from large to normal (e.g., 400% of normal display to 100% of normal display) and at some point in time, the focus screen is no longer displayed. This gives the appearance to the user of zooming out of the focus screen (which contracts) to the parent screen (which also contracts). Illustratively, the contraction is also linear. However, it also need not be the case. There is no need for a three-dimensional display engine since the graphic appearances can be displayed using a two-dimensional display engine. Yet, the user still receives a three-dimensional viewing experience.

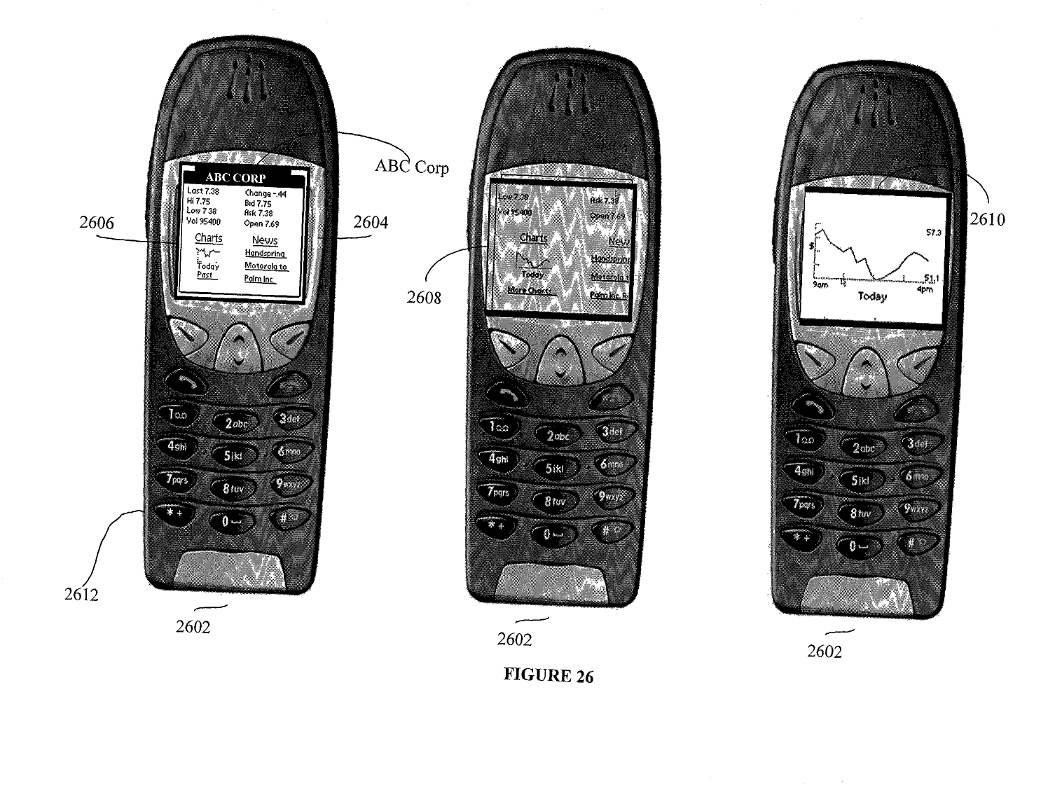

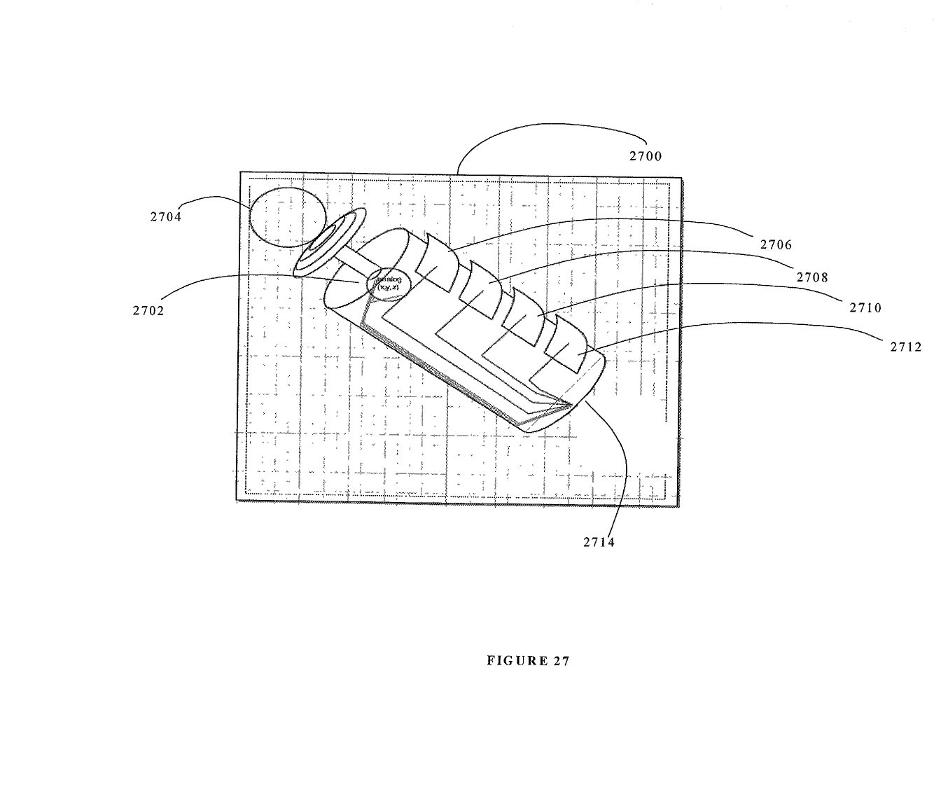

When panning, screens are modeled as a pyramidal structure based on hierarchy level and relative position of parent screens within the pyramid. For example, each screen can have a coordinate (x, y, z) location. The z coordinate corresponds to the hierarchical level of the screen. The x, y coordinates are used to indicated relative position to each other, base on where the parent screen is. For example, refer to the appearances of data objects 2604 and 2610 of FIG. 26. In the parent screen 2604, the “news” data object element is to the right of the “charts” data object element. The user changes the viewing perspective to the hierarchical level corresponding with the appearance 2610. The user can pan at this level. When panning right at this lower hierarchical level, the screen to the right is a more detailed screen, at that particular hierarchical level, of the travel region of the “news” data object element.

One embodiment of the viewing system 1000 addresses low bandwidth, memory and processor limited clients 1014. With high bandwidth and performance, these features become somewhat less critical, but are still very useful. Described above is an illustrative embodiment of the SZML™ format, which is essentially the ZML™ format transformed and optimized for direct screen display. The SZML™ format defines graphic appearances as vectors. The SZML™ format is much faster and simpler to render than the ZML™ format.

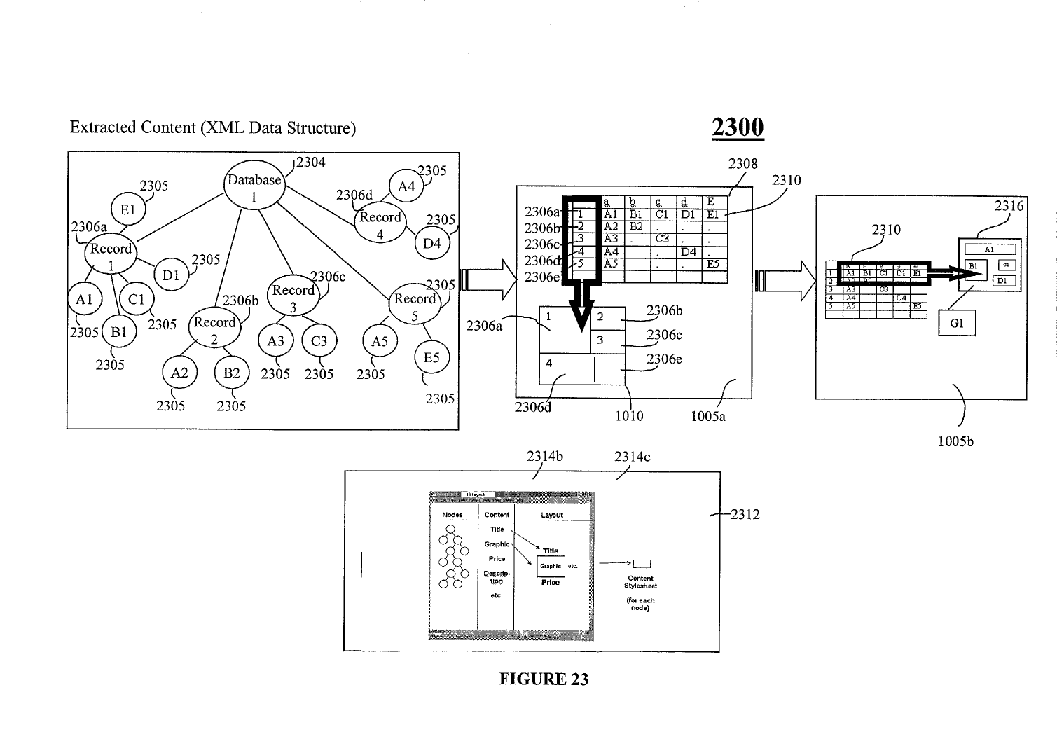

As mentioned above, the stylizer module 1004 employs the template 1005 having a spatial layout portion 1005a and a contents style portion 1005b. FIG. 23 is a block diagram 2300 illustrating how the spatial layout style portion 1005a and the contents style portion 1005b of the template 1005 operate to enable the stylizer module 1004 to convert an XML™ source content data structure extracted from a date source 2304 into ZML™ formatted data objects. The spatial layout style portion 1005a arranges a plurality of data records 2306a-2306e in the multi-dimensional, virtual space 1010 independent of the details 2305 in each of the records 2306a-2306e. For example, if the source content 2304 is a list of a doctor's patients, the spatial layout style portion 1005a arranges the records 2306a-2306e, relative to each other, in the virtual space 1010 based on the person's name or some other identifying characteristic. The spatial layout style portion 1005a generally does not deal with how the data 2305 is arranged within each record 2306a-2306e. As previously discussed, the nature of the arrangement (e.g., mapping) is variable, and relates to a particular physical paradigm. This mapping, in one embodiment, translates to a function wherein the three-dimensional coordinates of the data objects are a function of the one-dimensional textual list of the data objects and the template 1005.

After the spatial layout style portion 1005a assigns the records 2306a-2306e to locations in the virtual space 1010, the contents style portion 1005b determines how to render each record detail 2305 individually. A shoe store, a Web search engine, and a hotel travel site, for example, typically would all display their individual products and/or services and thus, record detail 2305, differently. The contents style portion 1005b creates the user-friendly style, and arranges the data 2305 within each record 2306a-2306e. Referring back to the patient example, the contents style portion 1005b arranges the patient's information within a region 2316 (e.g., a plate), placing the title A1 on top, the identification number B1 of the patient over to the left, charts in the middle and other information D1 in the bottom right comer.

The viewing system 1000, optionally, provides a graphical interface 2312 for enabling the user to easily modify the template 1005. As depicted the interface 2312 includes a display screen 2313. The display screen 2313 includes a portion 2314a that enables the user modify hierarchical connections. The display screen 2313 also includes a portion 2314b that enables the user to change the content of particular data nodes, and a portion 2314c that enables the user to change the display layout of particular data nodes.

Once the stylizer module 1004 has arranged all of the data objects spatially using the template 1005, the data objects are now in ZML™ format, and the have a location in the multi-dimensional, virtual space 1010. The stylizer module 1004 transfers the data objects in ZML™ format to the protocolizer module 0106 for further processing.

The protocolizer module 1006 receives the data objects in the ZML™ format and transforms the data objects to a commonly supported protocol such as, for example, WAP, HTML, GIF, Macromedia FLASH™ and/or JAVA™. The protocolizer module 1006 converts the data objects to established protocols to communicate with a plurality of available clients 1014 and browsers 1018 to display the data objects from an adjustable viewing perspective in the navigable, multi-dimensional, virtual space 1010. For example, a Macromedia FLASH™ player/plug-in is available in many browsers and provides a rich graphical medium. By translating the ZML™ formatted data objects to Macromedia FLASH™ compatible code, the data objects in the spatial hierarchy (i.e., ZML™ format) can be browsed by any browsers with a Macromedia FLASH™ player/plug-in, without any additional software.

In one embodiment, the protocolizer module 1006 is implemented as a servlet utilizing JAVA™, C, WAP and/or ZML™ formatting. The protocolizer module 1006 intelligently delivers ZML™ formatted data objects as needed to client 1014. The protocolizer module 1006 preferably receives information regarding the bandwidth of the communication channel 1022 used to communicate with the client 1014. In the illustrative embodiment, the protocolizer module 106 delivers those data objects that are virtually closest to the user's virtual position. Upon request from the zoom renderer 1020, the protocolizer module 1006 transmits the data objects over the communication channel 1022 to the client 1014.

An example illustrating operation of the protocolizer module 1006 involves data objects relating to clothing and a template 1005 relating to the physical paradigm of a clothing store. Due to the number of data objects involved, it is unrealistic to consider delivering all the data objects at once. Instead, the protocolizer module 1006 delivers a virtual representation of each data object in a timely manner, based at least in part on the virtual location and/or viewing perspective of the user. For example, if the user is currently viewing data objects relating to men's clothing, then the protocolizer module 1006 may deliver virtual representations of all of the data objects relating to men's pants and shirts, but not women's shoes and accessories. In a model of the data objects as a node tree, such as depicted in FIGS. 12A-12C, the focus node 1202c is the node corresponding to the data object appearance 1206c displayed from the current viewing perspective shown by the camera 1216a. The protocolizer module 1006 delivers to the client 1014 those data objects that correspond to the nodes virtually closest the user's focus node 402c and progressively delivers data that are virtually further away. As discussed with regard to FIGS. 12A-12C, the viewing system 1000 employs a variety of methods to determine relative nodal proximity.

For example, referring once again to FIG. 12A, while the user is viewing the data object of node 402c, the protocolizer module 1006 delivers those nodes that are within a certain radial distance from the focus node 1202c. If the user is not moving, the protocolizer module 1006 delivers nodes 1202a, 1202b, 1202d and 1202e, which are all an equal radial distance away. As also discussed with regard FIG. 12A, calculating virtual distances between nodes can be influenced by the hierarchical level of the nodes and also the directness of the relationship between the nodes. As skilled artisans will appreciate, the importance of prioritizing is based at least in part on the bandwidth of the communication channel 1022.

The zoom renderer 1020 on the client 1014 receives the data transmitted by the protocolizer module 1006 authenticates data via checksum and other methods, and caching the data as necessary. The zoom renderer 1020 also tracks the location of the user's current viewing perspective and any predefined user actions indicating a desired change to the location of the current viewing perspective, and relays this information back to the protocolizer module 1006. In response to the viewing perspective location information and user actions from the zoom renderer 1020, the protocolizer module 1006 provides data objects, virtually located at particular nodes or coordinates, to the client 1014 for display. More particularly, the zoom renderer 1020 tracks the virtual position of the user in the virtual space 1010. According to our feature, if the user is using a mobile client 1014, the zoom renderer 1020 orients the user's viewing perspective in relation to the physical space of the user's location (e.g., global positioning system (“GPS”) coordinates).

The user can influence which data objects the protocolizer module 1006 provides to the client 1014 by operating the user controls 1007 to change virtual position/viewing perspective. As discussed above, delivery of data objects is a function of virtual direction (i.e. perspective) and the velocity with which the user is changing virtual position. The protocolizer module 1006 receives user position, direction and velocity information from the zoom renderer 1020, and based on this information, transmits the proximal data node(s). For example, in FIG. 12A, if the user is at node 1202c and virtually traveling toward nodes 1202e and 1202h, the protocolizer module 1006 delivers those nodes first.

As previously mentioned, the client 1014 can be any device with a display including, for example, televisions, a personal computers, laptop computers, wearable computers, personal digital assistants, wireless telephones, kiosks, key chain displays, watch displays, touch screens, aircraft watercraft or automotive displays, handheld video games and/or video game systems. In another embodiment, the kiosk does not contain a display. The kiosk only includes a transmitter (e.g., an IR transmitter) that sends targeted information to a user's client as the user travels within a close vicinity of the kiosk transmitter, whether or not the user requests data. The viewing system 1000 can accommodate any screen size. For example, clients 1014 such as personal digital assistants, a wireless telephones, key chain displays, watch displays, handheld video games, and wearable computers typically have display screens which are smaller and more bandwidth limited than, for example, typical personal or laptop computers. However, the stylizer module 1004 addresses these limitations by relating data objects in the essentially infinite virtual space 1010. The essentially infinite virtual space 1010 enables the user to view information at a macro level in the restricted physical display areas to pan through data objects at the same hierarchical level, and to zoom into data objects to view more detail when the desired data object(s) has been found. Bandwidth constraints are also less significant since the protocolizer module 1006 transfers data objects to the client 1014 according to the current location and viewing perspective of the user.

The zoom renderer 1020 processes user input commands from the user controls 1007 to calculate how data objects are displayed and how to change the users position and viewing perspective. Commands from the user controls 1007 can include, for example, mouse movement, button presses, keyboard input, voice commands, touch screen inputs, and joystick commands. The user can enter commands to pan (dx, dy), to (dz), and in some embodiments to rotate. The user can also directly select items or various types of warping links to data objects whereupon the user automatically virtually travels to selected destination.

The zoom render 1020 and the browser 1018 can be implemented in a variety of ways, depending on the client platform. By way of example, for PCs and Kiosks, JAVA™ can be used with, for example, graphic appearance libraries or a custom library with or without the JAVA Graphics™ API to create the zoom renderer 1020 and/or the browser 1018 for displaying the ZML™ formatted data objects in the virtual viewing space 1010. Alternatively, a custom C library can be used to create a stand-alone browser or plug-in. In another embodiment, Macromedia FLASH™ compatible code can be employed. For the PALM™ handheld, C software, the PALM™ Development Environment and PALM OS™ software can be employed. For wireless telephones, the zoom renderer 1020 and/or the browser 1018 can be implemented in the language of the telephone manufacturer. For televisions, the zoom renderer 1020 and/or the browser 1018 can be implemented within a cable receiver or an equivalent service.

The zoom renderer 1020 may reside on devices that are limited in capacity such as vehicle computers, key chains, and PDAs with limited memory and processing capabilities. Such devices often have limited and strained network bandwidth and are not designed for complicated graphic appearances. They may not have a typical browser 1018 that a personal computer would have. The following techniques help provide a high bandwidth experience over a low bandwidth connection (i.e., expensive experience over inexpensive capabilities). One goal of the following techniques are to keep the size of the code small, including a small stack and a small heap, using the heap over the stack. Another goal is to provide rapid graphic appearances with simple routines and small memory requirements. The following techniques can be variously combined to achieve desired goals.

One technique is for use with the ZML™ format. This technique uses parent-child relationships as impetus to minimize the need to specify explicit coordinates. It can be accomplished using a recursive table-like layout propagated over three-dimensional space. The table-like layout can contain n children per row, outside cell border percentages, intra cell border percentages, zoom-to, no screens. In the absence of explicit coordinates for ZML™ objects, a table layout may be employed within the ZML™ properties, such as children per row and outside, inside border percentages. Tables may be nested within tables. This method is analogous to HTML table layouts. The goal is to provide, at any given zoom level, a reasonable number of choices and a coherent display of information. Even though data objects are related to each other using a recursive, table-like layout, the coordinate system placement is not replaced entirely. This provides to the ability to place plates explicitly, independent of any parent or child.

Another technique is to get as much as possible off of the end device (e.g., thin client) by performing these conversion steps on another, more powerful CPU, starting with the system storing, in ZML™ format, a collection of one or more data objects. Then the viewing system 1000 takes the ZML™ format (ASCII) as an input and generates virtual plate structures from the ZML™ formatted data objects. The system 100 generates screens structures from the hierarchical plates. The viewing system 1000 generates, from screens, SZML™ formatted data objects (ASCII form) as output. The end result is a text file in SZML™ format that can be pasted into a PDA. This end result is a PDA application that does not have plate structures, screen structures, plate conversion function from ZML™ format, plate conversion functions to screens, and screen conversion functions to SZML™ format. Without these functions, the software is cheaper and faster.

Another technique is to truncate the ZML™ format to abbreviations (1-3 letters) to reduce characters as discussed above, for example:

bt=border thickness
n=name
p=parent

Another technique is to compress the ZML™/SZML™ format on the more powerful CPU and uncompress on the less powerful CPU. The system 100 uses a compression algorithm to compress ZML™ or SZML™ into a CZML™ or CSZML™ format. The system 100 decompresses to ZML™ or SZML™ format on the less powerful CPU.

Another technique is to preprocess the ZML™ to SZML™ format on another CPU format or store data objects in SZML™ format. However, there is a tradeoff. SZML™ formatted data objects have more characters because is the SZML™ format is essentially the ZML™ format expanded into its actual renderable elements, and thus it is larger. For example, it is one thing to describe the shape of a tea pot of size a, b, c and position x, y, z (i.e., ZML™ format) and it is another to describe every polygon in the tea pot (i.e., SZML™ format). The advantage is that SZML™ format is immediately ready for display. For example, where ZML™ format defines the existence of a rectangle in three-dimensional space and it is titled, located at this angle, and the like, SZML™ format explicitly commands the zoom renderer 1020 to draw the rectangle at screen coordinates (10, 20, 50, 60). Thus, investment up front, has perpetual payoff.

According to another technique, the viewing system 1000 summarizes ZML™ formatted information into screens; that is a collection of M×N displays on which the user would typically focus. Each screen is a list of vector graphic appearances objects. The viewing system 1000 then smoothly transitions between source and destination screens by linearly scaling the current view, followed by the destination view, as described above. This creates the effect of a true three-dimensional camera and graphic appearances engine (typically expensive) using primitive, inexpensive two-dimensional graphic appearances techniques.

According to another technique, the viewing system 1000 does not download everything, at once. Instead, the viewing system 1000 downloads the template(s) once and then subsequently only downloads irreproducible data. For example, if an appearance is defined by the example list of input variable for the exemplary financial template above, only the data for each data object has to be transmittal for the zoom renderer 1020 to display the data object. The layout of the appearance, the template, remains the same and the zoom renderer 1020 only changes the displayed values associated with each data object.

In one embodiment, as described above with respect to FIG. 23, the viewing system 1000 also includes a alteration program with a graphical user interface 2312 to enable the user to edit the definitions of data objects defined in ZML™ or SZML™ format, without the need of the user to understand those formats. The interface 2312 enables the user to manually change the zoomed layout of data objects like a paint program. The user selects graphic appearance tools and then edits the ZML™ or SZML™ formatted information manually using the interface 2312. For example, if there was special of the week, the user manually selects that node corresponding to the data object representing the special winter jackets and using the tools 2314a-2314c makes modifications such as scaling, shrinking, growing, moving, adding, deleting, or otherwise modifying the data object. Also, the user can use the interface 2312 to go beyond the layout algorithm and design the look and feel of the virtual space with greater control. The graphical alteration module operate in combination with the automated layout.

In addition to the software being ideal for many platforms, other hardware devices can augment the user experience. Since ZML™ and SZML™ formatted data can be lightweight (e.g., quick transmission and low memory requirements) using some of the compression/conversion algorithms, a PDA is an applicable client device 1014 for the viewing system 1000.

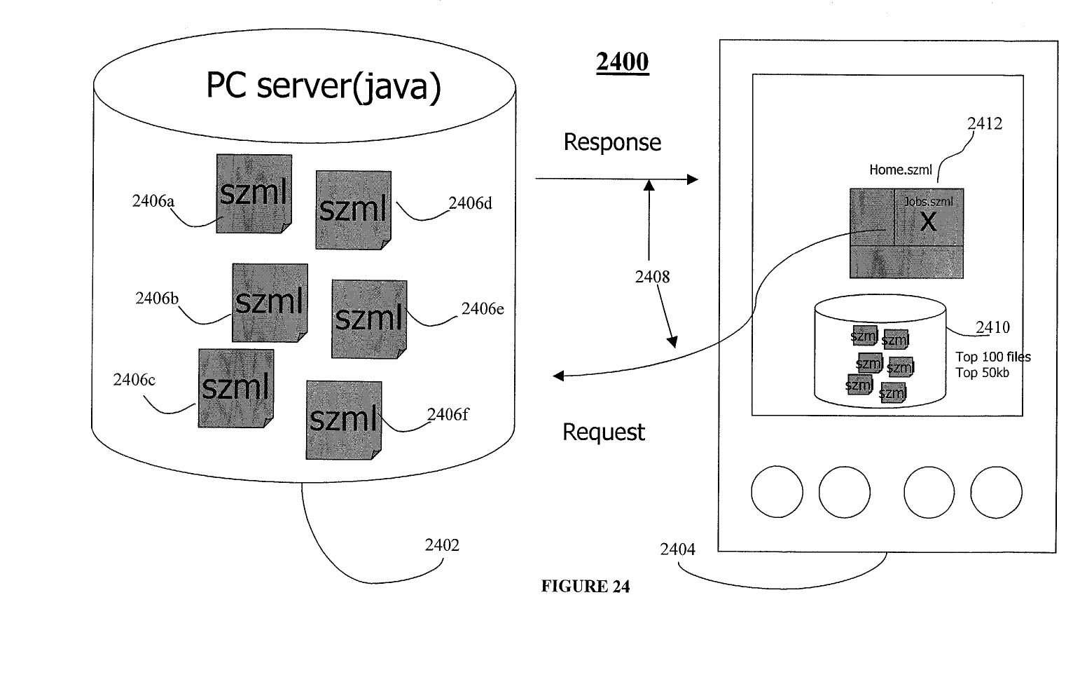

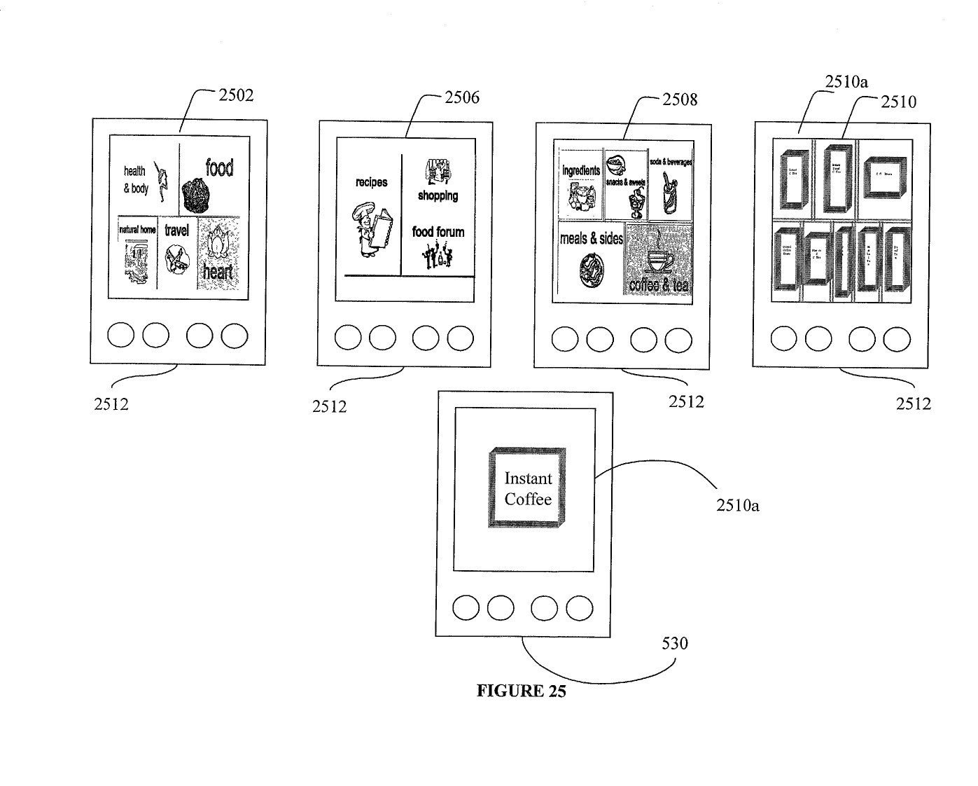

FIG. 24 is a conceptual block diagram 2400 depicting a database server 2402 in communication with a PDA 2404 which is zoom enabled in accord with an illustrative embodiment of the invention. The database server 2402 contains the data objects 2406a-2406f stored in the SZML™ format. The database server 2402 first transmits the data objects 2406a-2406f for the home screen 2412 via the communication channel 2408. As described above with regard to the downloading and compression, the data objects 2406a-2406f that are in the closest vicinity of the home screen in the spatial hierarchical relationship are downloaded next. The PDA 1604 has a small memory 2410 that can hold, for example, fifty kilobytes of information. Since the SZML™ formatted data objects 2406a-2406f are compact, the small memory cache 2410 can hold, for example, about one hundred SZML™ data objects 2406a-2406. Illustratively, FIG. 25 depicts various hierarchically related graphic appearances 2502-2510 and 2510a rendered on the PDA 2512. As depicted, the user navigates down through hierarchical levels of data objects from the graphic appearance 2502 of a retail store 2502 to the graphic appearance 2510a of a particular product.

Since the ZML™ and SZML™ data can be lightweight (e.g., quick transmission and low memory requirements) using some of the compression/conversion algorithms, wireless telephony devices are applicable clients for the viewing system 1000. FIG. 26 illustrates the telephony devices 2602a-2602c displaying the SZML™ data objects using a financial template and the linear expansion and contraction algorithm described above. The telephony device 2602a displays a graphic appearance 2604 of financial information for ABC Corp. The screen 2604 has a ‘click-region’ 2606 to expand the displayed chart to reveal to the user more detail of the chart. As described with regard to SZML™ format, the telephony device 2602b employs the above discussed linear expansion technique to provide the user with the graphic appearance 2608 and the feeling of zooming through the home graphic appearance 2604 to the zoom_to screen 2610. The telephony device 2602 depicts the zoom_to screen 2610 at its normal state (i.e., 100% ).

The user can virtually zoom through the data objects using the keypad 2612 of the telephony devices 2602. In another embodiment, the user uses a CellZoomPad™ (“CZP™”). The CZP™ device is a clip-on device for cellular telephony devices. The CZP™ device turns the cellular telephony device screen into a touch pad, similar to those found on portable PCs. Moving around the pad performs the zooming. The cell phone attachment covers the screen and keys of the cell phone. The user activates the touch pad by touching portions of the cell phone attachment, which activates certain of the cell phone keys in a manner that is read and understood by the zooming software on the cell phone, for example by using combinations of keys pressed simultaneously. Alternatively, a wire or custom plug-in interfaces directly with the cell phone.

Referring to FIG. 27, another device that can be used as a user control 1007 in conjunction with the viewing system 1000 is a handheld navigation device 2700. In one embodiment, the navigation device 2700 is wireless. The device 2700 is a handheld joystick-like device that is custom tailored for browsing in virtual space 1010. The MANO™ can be used across platforms and clients, for example a personal computer or a television. The device 2700 has an analog three-dimensional joystick 2702, with a loop 2704 on the top. In response to the user actuating the joystick north, south, east or west, the viewing system 1000 pans. In response to the user pushing in or pulling out on the loop 2704 the viewing system 1000 zooms. Optionally, the user can rotate the joystick 2702 to effectuate virtual rotational movement. Four buttons 2706-2712 can provide standard mouse functions, custom functions and/or redundant zooming functions. For example, the functions of the buttons can be to cause the system to take a snapshot of the virtual location of the viewing perspective, or a snapshot of the history (e.g., breadcrumb trail) of the user's trajectory. Other examples of functions can include purchasing an item, sending an email, synchronizing data to or from the client, transmitting information to/from a client device recording music and signaling an alarm (e.g. causing a system to dial 911). An Infrared Sensor 2714 option replaces a wired connection. Additionally, the device 2700 can be configured to vibrate in relation to user virtual movement, to provide tactical feedback to the user. This feedback can be in synchronization with the user's virtual movements through the multi-dimensional zoom space 1010 to give the user an improved sensory enriching experience. In another embodiment, the device 2700 has a speaker and/or microphone to give and/or receive audio signals for interaction with the system.

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A visual programming system comprising,
a hub and one or more adapters, said hub configured to communicate information with said one or more adapters by way of a common protocol, each of said one or more adapters being configured to communicate information between said hub and an associated operator, and
a user input interface that receives input from a user directing interconnection of at least one operator,
wherein said system is further adapted to automatedly combine functional aspects of said at least one operator in response to said input from said user.

2. The visual programming system of claim 1, wherein each of said one or more adapters is further configured to translate said common protocol to a protocol of said associated operator.

3. The visual programming system of claim 1, wherein each of said one or more adapters is further configured to translate said common protocol to a protocol of said associated operator, said associated operator communicates according to a communication protocol different from said common protocol.

4. The visual programming system of claim 1, wherein said system is further adapted to automatedly combine functional aspects of said a first operator and a second operator in response to said input from said user by communicatively connecting said first operator to said hub via a first one of said one or more adapters, and said second operator to said hub via a second one of said one or more adapters.

5. The visual programming system of claim 1, wherein each of said one or more adapters has a first interface substantially identical to a first interface of another adapter.

6. The visual programming system of claim 1, wherein at least one of said one or more adapters has a first interface and a second interface, said first and second interfaces communicating bidirectionally.

7. The visual programming system of claim 1, wherein a number representing a quantity of said one or more adapters that are unique is less than or equal to a number representing a quantity of said operators.

8. The visual programming system of claim 1, wherein an operator has an input port and an output port, each port communicating at least unidirectionally.

9. The visual programming system of claim 1, wherein at least one of said operators is derived from an external source.

10. The visual programming system of claim 9, wherein said external source is a Web site.

11. The visual programming system of claim 9, wherein said external source is substantially real-time information source.

12. The visual programming system of claim 9, wherein said external source is derived from said user.

13. The visual programming system of claim 1, wherein said external source is a file system.

14. The visual programming system of claim 1, wherein said external source is a legacy database.

15. The visual programming system of claim 1, further adapted to enable interoperation of a first functional aspect of one said operator with a second functional aspect of said one operator.

16. The visual programming system of claim 1, further adapted to contextually activate said functional aspects of said at least one operator.

17. The visual programming system of claim 1, wherein at least one of said operators is an application software program.

18. The visual programming system of claim 1, wherein said system is further adapted to combine functional aspects of a single said operator in response to said input from said user.

19. The visual programming system of claim 1, wherein said system is further adapted to generate a graphical representation of operation of a functional aspect of at least one said operator.

20. The visual programming system of claim 14, wherein said functional aspect is an output from said operator.

21. The visual programming system of claim 14, wherein said system is further adapted to said graphical representation of said operation of said functional aspect substantially in real-time.

22. A method of visual programming comprising,
receiving input from a user directing interconnection at least one operator, and
automatedly combining functional aspects of said at least one operator in response to said receipt of said input from said user.

23. The visual programming method of claim 22, wherein each operator has an associated protocol, and wherein said method further comprises translating from said associated protocol to a common protocol.

24. The visual programming method of claim 22, further comprising translating from said common protocol to said associated protocol of said associated operator.

25. The visual programming method of claim 22, wherein an operator has an input port and an output port, each port communicating at least unidirectionally.

26. The visual programming method of claim 22, wherein at least one of said operators is derived from an external source.

27. The visual programming method of claim 26, wherein said external source is a Web site.

28. The visual programming method of claim 26, wherein said external source is substantially real-time information source.

29. The visual programming method of claim 26, wherein said external source is derived from said user.

30. The visual programming method of claim 22, wherein said external source is a file system.

31. The visual programming method of claim 22, wherein said external source is a legacy database.

32. The visual programming method of claim 22, wherein at least one of said operators is an application software program.

33. The visual programming method of claim 22, wherein said method is further adapted to combine functional aspects of a single said operator in response to said input from said user.

34. The visual programming method of claim 22, wherein said method is further adapted to generate a graphical representation of operation of a functional aspect of at least one said operator.

35. The visual programming method of claim 32, wherein said functional aspect is an output from said operator.

36. The visual programming method of claim 32, wherein said method is further adapted to said graphical representation of said operation of said functional aspect substantially in real-time.
